(19) United States
(12) Patent Application Publication
(10) Pub. No.: US 2016/0023588 A1
(43) Pub. Date: Jan. 28, 2016

(54) Removable Signaling Apparatus, System, and Method

(71) Applicant: Classic Safety Products, LLC, Wakefield, RI (US)

(72) Inventor: John Samuel Peterson, Kingston, RI (US)

(21) Appl. No.: 14/341,555

(22) Filed: Jul. 25, 2014

(51) Int. Cl. B60Q 1/00; B60Q 1/26; B60Q 1/34; H05B 37/02; H05B 33/08

(52) U.S. Cl. CPC B60Q 1/0094; H05B 37/0272; H05B 33/0803; B60Q 1/34; B60Q 1/2615

(57) ABSTRACT

A wireless, removable vehicle signaling control and illumination apparatus which may be for use on vehicles. The system may utilize a miniature digital radio transceiver inside a lamp housing to provide wireless control of the lamp. The signaling system may provide a signaling solution for a user which does not require alteration or modification of the vehicle. Such a system may improve conspicuity, safety, and illumination capabilities of the vehicle.

### CROSS-REFERENCE TO RELATED APPLICATIONS

This is a continuation in part application of U.S. patent application Ser. No. 14/324,882, filed Jul. 7, 2014 and titled” SELF CONTAINED, REMOVEABLE, WIRELESS TURN SIGNAL SYSTEM FOR MOTOR VEHICLES AND TRAILERS”, which is a continuation of U.S. patent application Ser. No. 12/798,219, filed Mar. 31, 2010, and titled “Self-contained, Removable, Wireless Turn Signal System for Antique Vehicles”, which claims the benefit of provisional patent application Ser. No. 61/212,023, filed Apr. 4, 2009, and entitled “SELF-CONTAINED, REMOVEABLE, WIRELESS TURN SIGNAL SYSTEMS FOR VEHICLES” all of which are hereby incorporated by reference herein in their entirety.

The application also claims the benefit of provisional patent application Ser. No.61/958,293, filed Jul. 25, 2013 and entitled “Wireless, Readily-Removable, Non-contact Method for Detecting Vehicle Pedal and Lever Actuation for Illumination of Vehicle Signal Lamps” which is herby incorporated by reference herein in its entirety.

### BACKGROUND

1. Field of Disclosure

This disclosure relates to signaling devices. More specifically, this disclosure relates to signaling devices for vehicles and trailers.

2. Description of Related Art

Currently, vehicles are factory equipped with a large variety of safety devices. Over the last century or so, these devices have evolved, been adopted, and, in some cases, mandated by law. As a result, vehicles today are less prone to be in accidents and are generally safer than their predecessors. One such example of safety devices is the range of automotive lighting found on vehicles produced today.

Early vehicles in many instances did not include automotive lighting. As time progressed, automotive lighting began to evolve, becoming more and more common on factory produced cars. This lighting, however, was still subject to a number of pitfalls. For example, such lights were generally low luminosity. Additionally, signals on vehicles took time to evolve as well. In fact, before 1950, most cars were not manufactured with turn signals. Since antique vehicles are a significant hobby in the United States and worldwide, many of these vehicles are still driven. In the United States alone, millions of vehicles considered “antique” are still on the roads.

Since many of these vehicles lack various signals, they are perceived as being unsafe and present a serious safety risk to both the drivers of these vehicles and others on the roadway. Though hand signals may be used to indicate a driver's intentions, such signals are not a complete solution since they do not provide lighting. Additionally, these signals are not readily understood by today's drivers.

There is little enthusiasm in the antique vehicle community, however, to modify vehicles in order to install lighting and signaling devices. Such installation would involve cutting original vehicle wiring, running new wire looms, cutting fenders, cutting bumpers, and/or otherwise physically modifying a vehicle.

On the contrary, it is highly desirable that a vehicle be in a condition which is as close to original as possible. Therefore, there is considerable incentive to spend large amounts of time and money to meticulously restore a vehicle to original condition as a vehicle in original condition is more valuable and will be better judged when shown.

Currently, kits and systems do exist which allow an owner to install lighting and signals to their vehicle. These kits and systems do, however, require hard wiring and/or physical alteration of the vehicle and are consequentially not widely used. These kits are expensive. This is compounded by the fact that antique vehicle owners tend to buy and sell vehicles with high frequency. A new kit would need to be purchased and installed for each vehicle since such kits and systems are not easily removable. Many kits offer only a modest increase in vehicle conspicuity due to poor light output and visibility. Furthermore, such kits generally lack fault detection capabilities and, if installed poorly, may be subject to short circuits, unreliability, etc.

### SUMMARY

In accordance with an embodiment of the present disclosure, a remote controlled vehicular light bulb may comprise a lighting element. The remote controlled vehicular light bulb may comprise a radio unit. The remote controlled vehicular light bulb may comprise a controller. The controller may be configured to control illumination of the lighting element based upon a control signal received by the radio unit. The remote control vehicular light bulb may comprise a housing. The housing may be configured to interface and receive power from a standard vehicular light bulb socket. The housing may comprise a base and a bulb.

In some embodiments, the lighting element may include at least one light emitting diode. In some embodiments, the lighting element may include a plurality of light sources which are configured to be illuminated in tandem and/or individually as commanded by the controller. In some embodiments, the controller may be configured to transmit a repeater signal via the radio unit. In some embodiments, the controller may be configured to detect a fault condition in the remote controlled vehicular light bulb. In some embodiments, the controller may be configured to transmit a fault indication signal via the radio unit. In some embodiments, the controller and radio unit are embedded in a single integrated circuit. In some embodiments, the radio unit may include a transceiver.

In accordance with another embodiment of the present disclosure, a remotely controlled vehicular lighting system may comprise at least one vehicular light. Each of the at least one vehicular light, may comprise radio unit. Each of the at least one vehicular light may comprise a microprocessor. Each of the at least one vehicular light may be configured to interface and draw power from a pre-existing vehicular light bulb socket. The vehicular lighting system may comprise a controller. The controller may be configured to generate a control signal. The control signal may comprise a first unique identifier which is associated with the controller. The control signal may comprise a second unique identifier which is associated with the intended recipient vehicular light of the at least one vehicular light. The control signal may comprise a command. The microprocessor of each of the at least one vehicular light may be configured to receive, via the radio unit, the control signal from the controller. The microprocessor may be configured to execute the command if the vehicular light has been operatively paired with the controller associated with the first unique identifier and the vehicular light is associated with the second unique identifier.

In some embodiments, each of the at least one vehicular light may include a configuration adapter. In some embodiments, each of the at least one vehicular light may include an on-board power. In some embodiments, each of the at least one vehicular light may be configured to be removably coupled to a surface of a vehicle. In some embodiments, the command may specify a desired behavior of the vehicular light. In some embodiments, each of the at least one vehicular light may include a lighting element. In some embodiments, the command may specify whether the lighting element should illuminate and/or in what fashion the lighting element should illuminate. In some embodiments, the lighting element for each of the at least one vehicular light may include an LED. In some embodiments, the microprocessor of each of the at least one vehicular light may further be configured to generate a status signal, via the radio unit, indicating the status of that vehicular light. In some embodiments, the controller may include an indicia. In some embodiments, the indicia may indicate the status of one of the at least one vehicular light as indicated by a status signal generated by that vehicular light. In some embodiments, the controller may include an actuator, the actuator may be configured for use in selecting between the command to be sent in a control signal from a plurality of selectable commands. In some embodiments, a control signal generated by the controller may be encrypted. In some embodiments, the microprocessor of each of the at least one vehicular light may be configured to decrypt the signal. In some embodiments, the controller may include an on-board power source. In some embodiments, the controller may be configured to be removably coupled to a surface. In some embodiments, the controller may be configured to be removably coupled to a surface magnetically. In some embodiments, the radio unit of each of the at least one vehicular light may include a transceiver. In some embodiments, the lighting element of each of the at least one vehicular light may include a plurality of light sources which are configured to be illuminated in tandem and/or individually as commanded by the microprocessor of each of the at least one vehicular light. In some embodiments, the microprocessor of each of the at least one vehicular light may be configured to transmit a repeater signal via the radio unit of each of the at least one vehicular light.

In accordance with another embodiment of the present disclosure, a remote controlled vehicular light may comprise a lighting element. The remote controlled vehicular light may comprise a radio unit. The remote controlled vehicular light may comprise a controller. The controller may be configured to control illumination of the lighting element based upon a control signal received by the radio unit. The controller may only act on the control signal when the control signal includes an expected unique identifier. The remote controlled vehicular light may comprise a housing. The housing may comprise a base and a bulb. The housing may be configured to interface and receive power from a standard vehicular light bulb socket or be configured to be removably mountable to a vehicle.

In some embodiments, the control signal may include a command. The command may specify whether the lighting element should illuminate and/or in what fashion the lighting element should illuminate. In some embodiments, the controller may be configured to detect one or more fault condition in the remote control vehicular light. In some embodiments, when one of the one or more fault condition is detected, the controller may transmit a status signal indicating presence of that fault condition. In some embodiments, the lighting element may include a light emitting diode. In some embodiments, the radio unit may include a transceiver. In some embodiments, the controller may only act on the control signal when the control signal includes an expected unique identifier and a second expect unique identifier. In some embodiments, the expected unique identifier may be associated with the remote controlled vehicular light bulb or a system controller paired with the remote control vehicular light bulb. In some embodiments the second expected unique identifier may be associated with the remote controlled vehicular light or a system controller paired with the remote control vehicular light. In some embodiments, the lighting element may include a plurality of light sources which are configured to be illuminated in tandem and/or individually as commanded by the controller. In some embodiments, the controller may be configured to transmit a repeater signal via the radio unit. In some embodiments, the remote controlled vehicular light may be configured to be magnetically mountable on the vehicle.

In accordance with another embodiment of the present disclosure, a remotely controlled vehicular lighting system may comprise a sensing controller. The remote controlled vehicular lighting system may comprise at least one vehicular signal light. Each of the at least one vehicular signal light may comprise a radio unit, and a microprocessor. The microprocessor of each of the at least one vehicular signal light may be configured to receive, via the radio unit, a control signal command from the sensing controller and execute the command if the vehicular signal light has been operatively paired with the sensing controller. The sensing controller may include a sensor and a processor. The processor may be configured to analyze data from the sensor to determine if a condition of interest exists and upon determination that the condition of interest exists, generate the control signal command.

In some embodiments, the condition of interest may be the actuation of a brake pedal. In some embodiments, the condition of interest may be the actuation of a directional lever. In some embodiments, the condition of interest may be the deceleration of the vehicle. In some embodiments, the condition of interest may be the illumination of a stock vehicular signal on a vehicle. In some embodiments, the sensor may be a current sensor and the condition of interest may be determined to exist when data from the sensor indicates current flow through a wire running to the stock vehicular signal is above a predetermined threshold. In some embodiments, the sensing controller may include a clip. The clip may be configured to allow the sensing controller to be clipped around a wire running to the stock vehicular signal. In some embodiments the sensing controller may be couple to a vehicle magnetically. In some embodiments the sensing controller may include at least one additional sensor in addition to the sensor. In some embodiments, the sensor may be chosen from a group consisting of: an accelerometer, gyroscope, magnetometer, encoder, potentiometer, range finder, optical sensor, or current sensor. In some embodiments, the sensing controller may include an onboard power source. In some embodiments, the at least one vehicular signal light may comprise a base and a bulb. The base may be configured to interface and receive power from a standard vehicular light bulb socket. In some embodiments, the at least one vehicular signal light may be magnetically mountable to a vehicle. In some embodiments, the sensor may be a magnetic sensor and the system may further include one or more magnet which is stationary with respect to the vehicle.

In accordance with another embodiment of the present disclosure, method of a detecting brake pedal actuation and commanding at least one remote controlled vehicular signal light to illuminate in response to detected brake pedal actuation may comprise operatively coupling a sensing controller to a brake pedal such that a sensor included in the sensing controller is arranged to measure displacement of the brake pedal. The method may comprise placing the sensing controller in a learn mode. The method may comprise actuating the brake pedal. The method may comprise analyzing, with a processor included in the sensing controller, sensor data generated as the brake pedal was actuated in the learn mode and determining an algorithm for detecting brake pedal actuation. The method may comprise monitoring data generated by the sensor and determining if the data is indicative of brake pedal actuation. In response to the data being indicative of brake pedal actuation, the method may comprise commanding the at least one remote controlled vehicular signal light to illuminate via a wireless command signal.

In some embodiments, the sensor may be a magnetic sensor and the method may further comprise placing one or more associated magnet on the vehicle. In some embodiments, placing the sensing controller in a learn mode may comprise depressing a button on the sensing controller. In some embodiments, the method may further comprise monitoring data generated by the sensor and determining if the data is indicative of the brake pedal being released and in response to the data being indicative that the brake pedal has been released commanding the at least one remote controlled vehicular signal light to stop illuminating. In some embodiments, the at least one remote controlled vehicular signal light may comprise a base and a bulb, the base may be configured to interface and receive power from a standard vehicular light bulb socket. In some embodiments, the method may further comprise mounting the at least one remote controlled vehicular signal light to the vehicle magnetically. In some embodiments, operatively coupling a sensing controller to a brake pedal such that the sensor included in the sensing controller is arranged to measure displacement of the brake pedal may comprise operatively coupling the sensing controller to the brake pedal with a non-permanent attachment means. In some embodiments, commanding the at least one remote controlled vehicular signal light to illuminate via a wireless command signal may comprise sending the wireless command signal to the at least one remote controlled vehicular signal from a radio unit included in the sensing controller. In some embodiments, commanding the at least one remote controlled vehicular signal light to illuminate via a wireless command signal may comprise sending the wireless command signal to the at least one remote controlled vehicular signal from a radio unit included in a main controller which is in communication with the sensing controller. In some embodiments, the method may further comprise indicating on the main controller that the at least one remote controlled vehicular signal light is illuminating when the at least one vehicular signal light is illuminating.

In accordance with another embodiment of the present disclosure, a method for remotely controlling a vehicular lighting system may comprise installing an vehicular light configured to interface and draw power from a pre-existing vehicular light bulb socket into the pre-existing vehicular light bulb socket. The vehicular light may comprise a radio unit, and a microprocessor. The method may comprise controlling the vehicular light with a controller configured to generate a control signal. The control signal may comprise a first unique identifier which is associated with the controller, a second unique identifier which is associated with an intended recipient vehicular light, and a command. The method may comprise receiving with the microprocessor of the vehicular light, via the radio unit, the control signal from the controller. The method may comprise the vehicular light executing the command if the vehicular light has been operatively paired with the controller associated with the first unique identifier and the vehicular light is associated with the second unique identifier.

In some embodiments, the method may further comprise attaching a configuration adapter to the vehicular light. In some embodiments, the method may further comprise specifying within the command a desired behavior of the vehicular light. In some embodiments, the method may further comprise providing a lighting element in the vehicular light. In some embodiments, the method may further comprise specifying within the command whether the light element should illuminate and/or in what fashion the lighting element should illuminate. In some embodiments, the method may further comprise generating a status signal, via the radio unit, indicating the status of the vehicular light. In some embodiments the method may comprise indicating with an indicia on the controller the status of the vehicular light as indicated by the status signal generated by the vehicular light. In some embodiments, the method may further comprise actuating an actuator on the controller so as to select the command to be sent in the control signal from a plurality of selectable commands. In some embodiments the method may further comprise encrypting the control signal generated by the controller and decrypting the control signal with the microprocessor of the vehicular light. In some embodiments the method may further comprise providing an onboard power source in the controller and removably coupling the controller to a surface.

In accordance with another embodiment of the present disclosure, a remotely controlled vehicular lighting system may comprise a sensor unit. The sensor unit may include a sensor. The system may comprise a controller. The controller may be configured to receive data from the sensor unit. The system may comprise at least one vehicular signal light. Each of the at least one vehicular signal light may comprise a radio unit and a microprocessor. The microprocessor of each of the at least one vehicular signal light may be configured to receive, via the radio unit, a control signal command from the controller and execute the command if the vehicular signal light has been operatively paired with the controller. The controller may include a processor. The processor may be configured to analyze the data from the sensor unit to determine if a condition of interest exists and upon determination that the condition of interest exists, generate the control signal command.

In some embodiments, the condition of interest may be the actuation of a brake pedal. In some embodiments, the condition of interest may be the actuation of a directional lever. In some embodiments the condition of interest may be the deceleration of a vehicle. In some embodiments, the condition of interest may be the illumination of a stock vehicular signal on a vehicle. In some embodiments, the sensor may be a current sensor and the condition of interest may be determined to exist when data from the sensor unit indicates current flow through a wire running to the stock vehicular signal is above a predetermined threshold. In some embodiments, the sensor unit may include a clip. The clip may be configured to allow the sensor unit to be clipped around a wire running to the stock vehicular signal. In some embodiments, the sensor unit may be coupled to a vehicle magnetically. In some embodiments, the sensor unit may include at least one additional sensor in addition to the sensor. In some embodiments, the sensor may be chosen from a group consisting of: an accelerometer, gyroscope, magnetometer, encoder, potentiometer, range finder, optical sensor, or current sensor. In some embodiments, sensor unit may include an onboard power source. In some embodiments, the at least one vehicular signal light may comprise a base and a bulb, the base may be configured to interface and receive power from a standard vehicular light bulb socket. In some embodiments, the at least one vehicular signal light may be magnetically mountable to a vehicle. In some embodiments, the sensor may be a magnetic sensor and the system may further include one or more magnet which is stationary with respect to the vehicle. In some embodiments, the controller may be configured to receive data from the sensor unit wirelessly. In some embodiments, the controller may include a user interface configured to allow selection of a desired control signal command from a plurality of selectable control signal commands.

In accordance with another embodiment of the present disclosure, a remotely controlled vehicular lighting system may comprise a vehicular signal light. Each of the at least one vehicular signal light may comprise a radio unit, lighting element, and a microprocessor. The system may comprise a controller. The controller may include a user interface for selecting a desired signaling command from a plurality of signaling commands. The controller may be configured to communicate the desired signaling command to the radio unit of the vehicular signal light such that the microprocessor of the vehicular signal light receives the command and executes the command if the vehicular signal light has been operatively paired with the controller. The system may comprise a light sensor. The light sensor may be configured to sense ambient light conditions. The lighting element of the vehicular signal light may be caused to adjust in brightness in response to ambient light as sensed by the light sensor.

In some embodiments, the vehicular signal light may comprise a base and a bulb. The base may be configured to interface and receive power from a standard vehicular light bulb socket. In some embodiments, the vehicular signal light may be magnetically mountable to a vehicle. In some embodiments, the lighting element may be an LED array. In some embodiments, the light sensor may be housed in the vehicular signal light. In some embodiments, the lighting element of the vehicular signal light may be caused to adjust in brightness upon determination that ambient light conditions have crossed a predetermined ambient light threshold. In some embodiments, the ambient light threshold may define a brighter ambient light range and a darker ambient light range. In some embodiments, when the ambient light threshold is crossed from the brighter ambient light range to the darker ambient light range, the lighting element may be caused to dim. In some embodiments, when the ambient light threshold is crossed from the darker ambient light range to the brighter ambient light range, the lighting element may be caused to increase its light output. In some embodiments, the lighting element of the vehicular signal light may be caused to adjust in brightness in proportion to the amount of ambient light sensed by the light sensor. In some embodiments, the lighting element may increase in brightness as the amount of ambient light increases and dim as the amount of ambient light decreases.

### BRIEF DESCRIPTION OF THE DRAWINGS

These and other aspects will become more apparent from the following detailed description of the various embodiments of the present disclosure with reference to the drawings wherein:

FIG. 1 depicts an example representation diagram of a system in accordance with an embodiment of the present disclosure;

FIG. 2 depicts a flowchart detailing a number of example steps which may be used to operate a system;

FIG. 3 depicts a top-down, representational view of an exemplary controller;

FIG. 4 depicts a side, representational view of an example remote controlled signal bulb;

FIG. 5 depicts an exploded perspective view of a remote controlled signal unit;

FIG. 6 depicts an illustration of a number of signal units in place on a vehicle;

FIG. 7 depicts an representational view of an example high mount signal;

FIG. 8 depicts a perspective view of a specific example embodiment of a system;

FIG. 9 depicts a perspective, exploded view of a specific example lighting element of a signaling device;

FIG. 10 depicts a perspective, exploded view of a specific example signal body of a signaling device;

FIG. 11 depicts a bottom perspective view of a specific example embodiment of a signaling device;

FIG. 12 depicts a top-down view of an example embodiment of a magnet and scratch preventing member;

FIG. 13 depicts an example embodiment of a bracket which may be used to attach a signaling device to an object;

FIG. 14 depicts an example embodiment of a bracket with an example signaling device attached;

FIG. 15 depicts a top-down view of a specific example embodiment of a controller;

FIG. 16 depicts a flowchart detailing a number of example steps which may be used to identify a fault condition in a signaling device system;

FIG. 17 depicts a flowchart detailing a number of steps which may be used to identify and respond to a low battery condition of a signaling device in a signaling device system;

FIG. 18 depicts a flowchart which details a number of example steps which may be used to adjust the light output of a signaling device;

FIG. 19 depicts a flowchart which details a number of example steps which may be used to automatically cancel or turn off a turn signal in a signaling device system;

FIG. 20 depicts a flowchart detailing a number of example steps which may be used to automatically illuminate a brake light when a vehicle is decelerating;

FIG. 21 depicts a flowchart detailing a number of example steps that may be used to provide feedback related to the proximity of an object or objects to a vehicle;

FIG. 22A and FIG. 22B depict representational example embodiments of an a sensing controller which may be configured to detect brake pedal actuation and send a command to a signaling device in response to detection of brake pedal actuation;

FIG. 23 depicts a representational, top down view of the sensing controller depicted in FIG. 22A and FIG. 22B;

FIG. 24 depicts another representational example embodiment of a sensing controller;

FIG. 25 depicts another representational embodiment of an example sensing controller;

FIG. 26 depicts a flowchart detailing a number of example steps which may be used by a sensing controller to “learn” to detect a condition which would indicate that a signaling device should be illuminated;

FIG. 27 depicts a flowchart detailing a number of example steps which may be used by a sensing controller to “learn” to detect a condition which would indicate that a signaling device should be illuminated;

FIG. 28 depicts a flowchart detailing a number of example steps which may be used to detect a condition indicating a signaling device should be illuminated and to command one or more signaling device to illuminate as appropriate;

FIG. 29 depicts a flowchart detailing a number of example steps which may be used to detect a condition indicating a signaling device should be illuminated and to command one or more signaling device to illuminate as appropriate;

FIG. 30 to FIG. 31 depicts a progression of a representational example of a brake pedal 500 being depressed; and

FIG. 32 depicts a representation example embodiment of another sensing controller which may be used to detect a condition indicating a signaling device should be illuminated.

### DETAILED DESCRIPTION

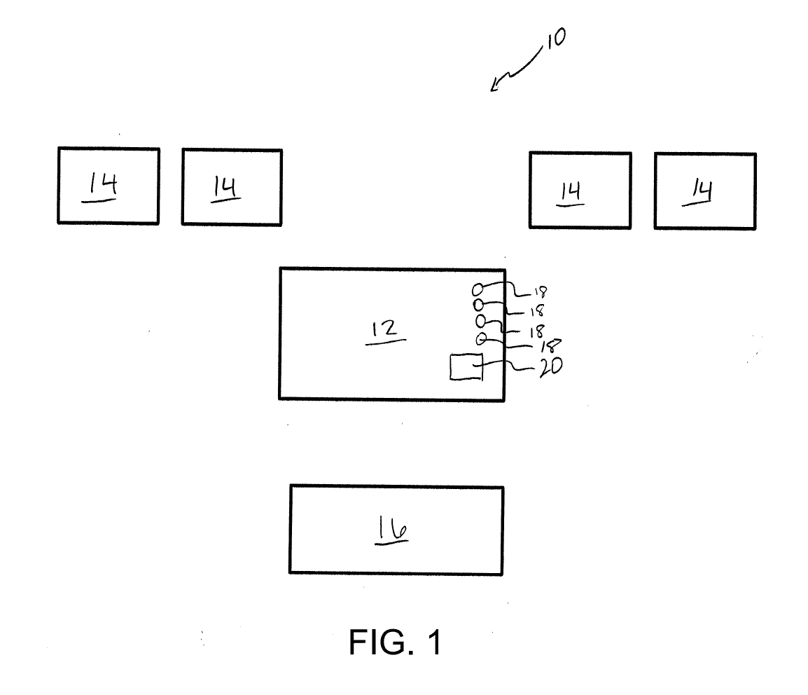

FIG. 1 depicts an example representational embodiment of a system 10. As shown, the system 10 includes a system controller or controller 12. The controller 12 may be used to control one or a number of signaling device(s) 14. In the example embodiment depicted in FIG. 1, four signaling devices 14 are depicted. Other embodiments may include any suitable number of signaling device(s) 14. The signaling devices 14 may include a lighting element, which in some specific embodiments may be an LED or LED array. In some embodiments, signaling devices 14 may include multiple lighting elements and/or a lighting element with multiple light sources which may be controlled in tandem or individually. The signaling devices 14 may include an on-board power source or interface with and draw power from the electrical system of a vehicle or vehicle in some embodiments.

The signaling devices 14 may be used for automotive signaling applications. It should be noted, that the terms automotive and vehicular as well as automobile and vehicle are used herein interchangeably. The terms “automotive”, “automobile”, “motor vehicle”, and the like are intended to be inclusive of any number of vehicles which may or may not be motor driven (e.g. cars, trucks, buses, trains, scooters, trailers, pedal carts, forklifts, horse and buggy, golf carts, ATV, snowmobiles, tractors, etc.). The signaling devices 14 may also be used for any other suitable signaling application. In automotive or vehicular applications, the signaling devices 14 may be configured for and used as (although not limited to): turn signals, brake lights, reverse lights, running lights, interior dome lights, fog lamps, cornering lamps, parking lights, side markers/signal repeaters, head lights, spotlights, auxiliary lights, any combination thereof, and so on. In some embodiments, a system 10 may be modular and additional desired signaling elements or devices 14 may be added to the system 10 as necessary and desired.

In embodiments where the signaling devices 14 are for automotive applications, such a system 10 may be particularly desirable for use in a vehicle which was not factory equipped with a desired signal or light (e.g. turn signal). It may be desirable that the signaling devices 14 may be installed without modification to the automobile, trailer, etc. It may also be desirable that the signaling devices 14 be easily or quickly removable. This may allow a user the safety benefits of the signaling devices 14 without sacrificing the originality or stock nature of a vehicle. When driving, a user may have the automobile equipped with the system 10, however, when showing the automobile, the system 10 may be quickly removed to return the automobile to a stock condition. Such a system 10 may further be advantageous as such a system 10 provides added safety benefits without affecting the monetary valuation of the automobile. Such a system 10 may also help a user to lower insurance rates for a vehicle which otherwise did not include one or more desired signal.

In some embodiments, the controller 12 may communicate with each of the signaling devices 14 via a wired connection. In the example embodiment shown, the controller 12 may communicate with each of the signaling devices 14 via a radio frequency control signal. This may be desirable because it may simplify installation, allow the signaling devices 14 to be placed in a wider variety of locations, and be more aesthetically pleasing. In such embodiments, each signaling device 14 may include an integrated circuit (hereafter IC), radio unit (which may include a receiver or transceiver), memory, microprocessor controller, and/or other component. In some specific embodiments, each signaling device 14 may include 2.4 GHz, 802.15.4 digital radio unit and IC microprocessor controlled system components. In embodiments where system communication is conducted via radio frequency, the radio unit of the signaling devices 14 may act as a signal receiver. Additionally, in some embodiments, signaling devices 14 may also act to relay commands or command other signaling devices 14. Again, this may be accomplished via a radio unit in the signaling devices 14. Other embodiments may use other suitable forms of wired or wireless communication. In some embodiments, a combination of wired and wireless communication may be used.

In various embodiments, each signaling device 14 may include one or more sensors. Any number of a variety of sensors may be included in a signaling device 14. In various embodiments, each signaling device 14 may for example include a temperature sensor. The temperature sensor may sense the ambient temperature around the vehicle. This may be useful in tracking and or determining battery life. In some embodiments, the ambient temperature may also be communicated to a controller 12. In some embodiment, temperature may be displayed on the controller 12. Each signaling device 14 may include, for example an ambient light sensor. Data from such a sensor may be used to control the signaling device 14 to a suitable brightness level while maximizing battery life. In some embodiments, a signaling device 14 may include a proximity sensor which may aid a user in parking of the vehicle. Signaling devices 14 may include other sensors as well. The controller 12 may include a number of indicia 18 and/or actuators 20 in various embodiments. In the example embodiment the controller 12 includes four indicia 18 and an actuator 20. The indicia 18 may be used to convey status, fault, or other information about the system 10. In some embodiments, indicia 18 may be used to convey status, fault, or other information about each signaling device 14 included in the system 10. In such embodiments, each signaling device 14 may be associated with a dedicated indicia 18. The indicia 18 may be any suitable variety of indicia. In some embodiments, the indicia 18 may be shaped as ISO automotive symbols. In some embodiments, the indicia 18 may be illuminated indicators such as LEDs.

The actuator(s) 20 may be used to control function of signaling device(s) 14 included in the system 10. The actuator(s) 20, may be used to specify whether signaling device(s) 14 should illuminate and in what fashion signaling device(s) 14 should illuminate. In some embodiments, controller 20 may include a single actuator 20 (as shown) which may control one of more functions of each signaling device 14 in the system 10. In other embodiments, different functions, signaling devices 14, or groups of signaling devices 14 may have dedicated actuators 20. For example, one actuator 20 may control running light functionality of signaling devices 14 while another actuator 20 may control turn signaling functionalities of signaling devices 14. The actuator(s) 20 may be any suitable variety of actuator. In some embodiments, the actuator(s) 20 may be any or a combination of a toggle switch, button, slider, input knob, input wheel, lever, touch screen, or the like. Once a desired function has been selected via the actuators(s) 20, the controller 12 may generate a control signal commanding that function to be executed by the signaling device(s) 14.

In some embodiments, software for the controller 12 may exercise additional control over system 10 components (e.g. automatically adjusting signal device 14 illumination brightness or signaling device illumination oscillation). Software for the controller 12 may also control when and how various indicia 18 will convey system 10 information to a user. The controller 12 may also be used to analyze any incoming sensor data and status data from signaling devices 14 or other system 10 components. In some embodiments, a controller 12 may also analyze sensor data generated from one or more sensor included in the controller 12.

In some embodiments, the controller 12 may be configured with a speaker (not shown). In such embodiments, the speaker may produce audible noise in coordination with the indicia 18 to convey system 10 information. In some embodiments, a speaker may be used in place of the indicia 18. In some embodiments, the speaker may function as a tell-tale indicator to indicate a signal is functioning.

In some embodiments, the controller 12 may be configured with a microphone (not shown). In such embodiments, the microphone may be used in place of or in addition to an actuator 20. In such embodiments, the controller 12 may control the system 10 via a voice commands given to a natural language user interface. In some embodiments, the controller 12 may include a graphical user interface (not shown). In such embodiments, a graphical user interface may be included in addition too, or instead of indicia 18 and/or actuator(s) 20. A user may use a graphical user interface to view system 10 information and/or control system 10 operation. In embodiments including a graphical user interface, the graphical user interface may be a touch screen user interface or any other suitable user interface.

In some embodiments, the controller 12 may include one or more of a variety of sensors. The controller 12 may, for example, include a battery level sensor. In some embodiments, the controller may include an accelerometer, gyrometer, or other inertial sensor. Such a sensor or sensors may be used in conjunction with like sensors on other system 10 components. This may help to provide information on how the vehicle is traveling and may, in some embodiments, be used to inform how the controller 12 controls operation of the signaling devices 14. The controller 12 may also include any number of other sensors in addition to those listed above.

In some embodiments, the controller 12 may be a device which is not solely dedicated to the system 10. In such embodiments, the controller 12 may be a smartphone, tablet, or the like which communicates wirelessly with various components of the system 10. The smartphone or tablet may run an app which allows a user to control the various signaling devices 14 of a system 10. The app may additionally act as a graphical user interface for the system 10 which displays and produces feedback for the user. In some embodiments, a smartphone, tablet, or other non-dedicated device may be used to control the system 10 in addition to a dedicated controller 12 which is included in the system 10.

Also as shown in FIG. 1, a system 10 may include a charger 16. The charger 16 may be used to charge various components of a system 10. A charger 16 may include any suitable power components needed to properly charge system 10 components. In some embodiments, the charger 16 may draw power from a standard wall outlet. In some embodiments, the charger 16 may be charged from a mobile power source such as an automobile's electrical system. In such embodiments, the charger 16 may draw power through the cigarette lighter receptacle of an automobile. In some embodiments, the charger 16 may include adapters (not shown) such that it may be used with multiple different types of power sources. System 10 components may include charge ports which may interface with wiring from the charger 16 such that the components may be charged by the charger 16.

A sensing controller such as a remote brake sensor which may include a transceiver or transmitter, may also actuate system 10 components in some specific embodiments. Such a sensing controller may be used in place of or in addition to the controller 12 as an auxiliary controller. Embodiments of such a sensing controller will be described later in the specification.

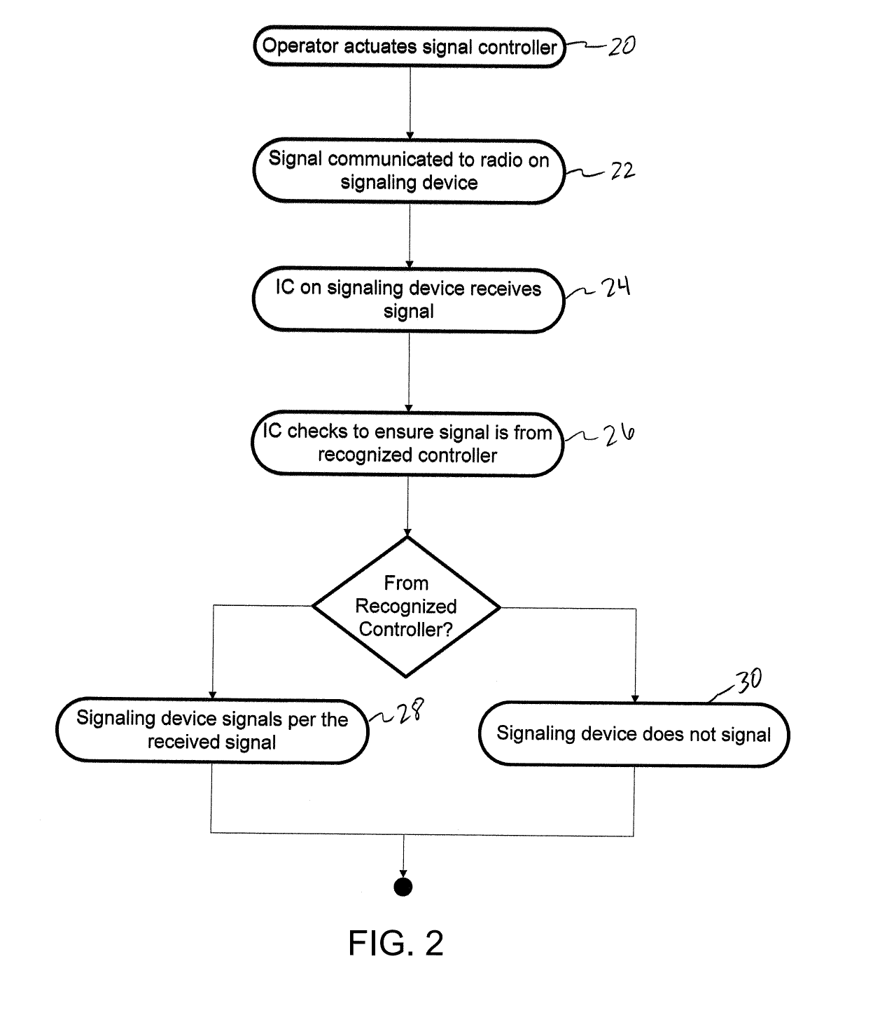

A user may equip their automobile, trailer or other vehicle with the signaling device(s) 14 and controller 12. With the system 10 components installed, a user may then be able to use the system 10. Referring now to FIG. 2, a flowchart depicting a number of example steps which may be used operate the system 10 is shown. The flowchart in FIG. 2 details steps which may specifically be used to operate a system 10 in which communication between components is conducted via radio frequency. As shown, the system logic begins when the vehicle operator actuates the signal controller in step 20. This may, for example, be done while driving to indicate that the vehicle operator will be turning their vehicle in a short period of time. In response to actuation, the controller may generate, in step 22, a signal which is communicated to a radio receiver or transceiver on a signaling device. The signal generated may be a unique signal. This signal may be configured such that it may only command signaling devices which have been associated with the controller. The signal may identify which out of a number signaling devices the signal is intended for. The signal may also identify what behavior is being commanded (turn on turn signal, turn on running lights, turn on reverse lights, etc.). In some embodiments, communication between system components may be encrypted and the system components may decrypt received communications. In such embodiments, any suitable encryption scheme may be used.

The radio and IC on each system component may then receive the signal in step 24. The IC microcontroller on each system component may then check the signal to ensure that the signal is from a recognized system controller (controller which the component has been associated, grouped, or paired with) in step 26. In such embodiments, after receiving the signal, the IC on each component may then decode a unique digital serial number (or in some embodiments, multiple unique identifiers) as well as the command. The IC on each component may check the unique digital serial number to ensure that it is from a member of the grouped system. If the signal is from a member of the grouped system, the system component may then perform the requested system function in step 28. As mentioned above, this system function may be requested via a controller. Performing the system function may, for example, include lighting the signaling lamps as requested. In the event that the signal is not from a grouped component, the system logic may proceed to step 30 in which the system component not perform the system function.

The functional result of the logic detailed in FIG. 2 is the driver's command being delivered, and then an LED array, for example, on a removable signaling device illuminating, providing signaling functions on the vehicle. This may, for example, be useful in warning other vehicles of the vehicle's presence or intent to turn. Additionally, the logic helps ensure that a signaling device only lights as intended by a vehicle's operator.

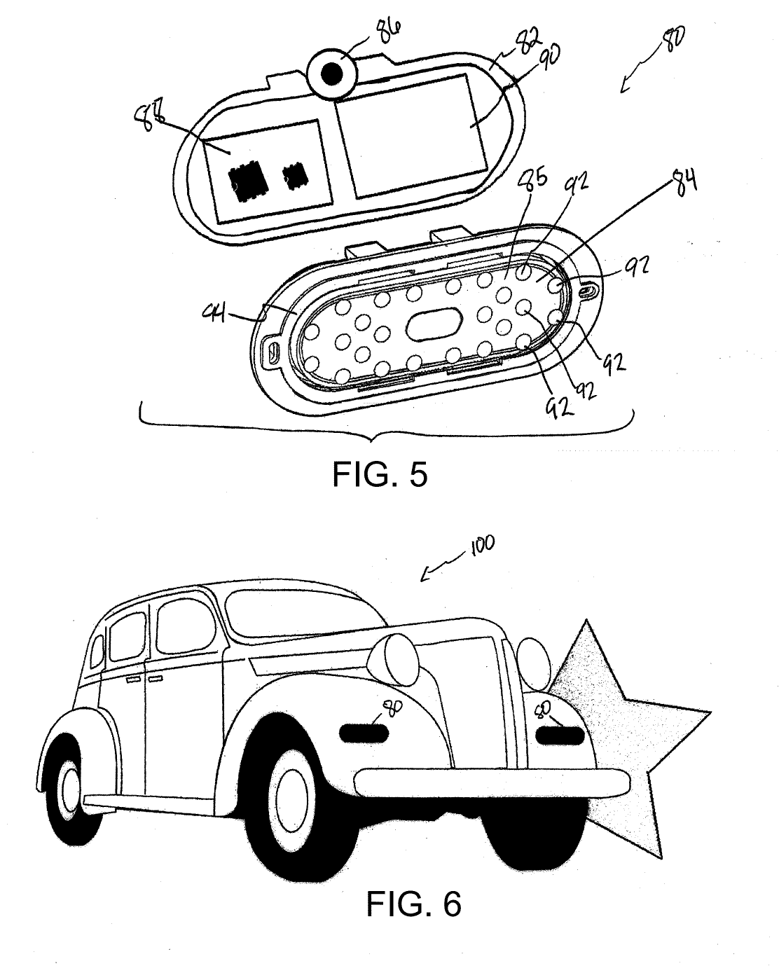

This signaling may come from any signaling device described herein. The signaling may, in some embodiments, be emitted from a removable signal, magnetically-mounted on the vehicle (see FIG. 5), and/or from a remote controlled bulb (see FIG. 4), placed into an existing socket on the vehicle. In the case of the remote controlled bulb, the remote controlled bulb might replace a simple, standard tail lamp, but transform that same lamp location into an expanded functionality signal. For example, the remote controlled bulb may add turn signaling and/or braking or other illumination signal functionality to a lamp location.

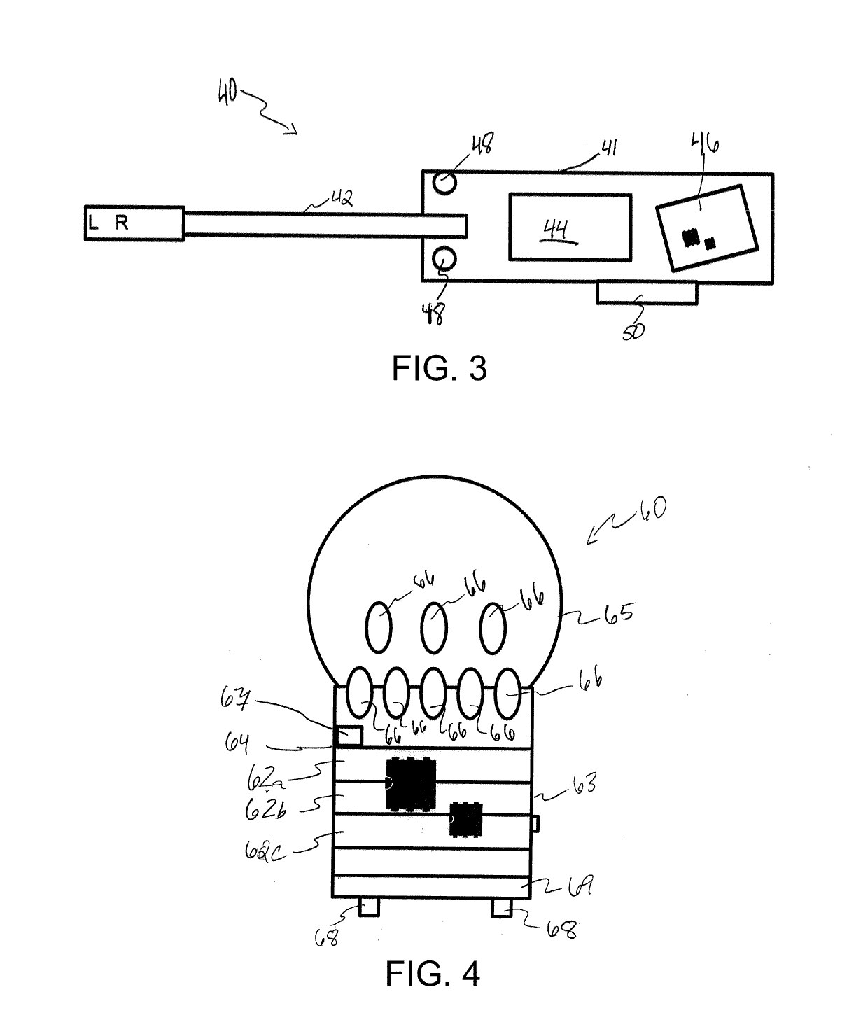

FIG. 3 illustrates a top-down, representational view of an exemplary system controller or controller 40. Specifically, the controller 40 shown in FIG. 3 is a battery-operated controller 40 with a vehicle signal lever 42. This specific controller 40 may be configured for use as an in-car controller 40 which may be used as a turn signal actuator. Other system controllers may be configured to control additional signal functions (e.g. brake light, running light, head light, reverse, and the like).

In the example embodiment depicted in FIG. 3, the controller 40 includes a housing 41. The example controller 40 contains at least one battery 44, a digital radio and microcontroller 46, and indicator lights 48. The battery 44 may, in some embodiments, be a rechargeable battery. In some embodiments, it may be desirable that the battery 44 be a miniature type battery (i.e. a battery with a high energy density such as a lithium-ion battery). The digital radio and microcontroller 46 may be included on a single part or PCB. The digital radio may be a radio-on-chip digital radio and included on the microcontroller chip. The indicator lights 48 may, in some embodiments, be LEDs. The indicator lights 48 may be used to indicate system status or faults. In other embodiments, a controller 40 may include different or additional components. For example, a controller 40 may include one or more actuators (not shown) instead of or in addition to the vehicle signal lever 42 in FIG. 3. In some embodiments, a vehicle signal lever 42 or actuator on a controller 40 may include a self cancelling feature which automatically causes the signal to turn off. In some embodiments, the vehicle signal lever 42 may be caused to return to a non actuated position when the controller 40 turns off the signal.

The controller 40 may be attached to a convenient portion of an automobile. It may be desirable that the controller 40 be removably attached to the automobile. In the example embodiment shown in FIG. 3, a coupling member 50 is included on the controller 40 to facilitate coupling to an automobile. In some embodiments, the coupling member 50, may be a magnet. In such embodiments, the controller 40 may be magnetically attached to the dashboard or other metal part of the interior of a vehicle. In other embodiments, the coupling member 50 may differ. For example, the coupling member 50 may be or include a suction cup or the like, a clamp member, a bracket which may be bolted or otherwise attached to a portion of an automobile, adhesive pad, etc. Preferably, the coupling member 50 may be used to attach the controller 40 to an automobile without any modification of or damage to the automobile.

A user may signal with the controller 40 by actuating the vehicle signal lever 42 in the example embodiment. For example, a user may actuate the vehicle signal lever 42 by displacing the vehicle signal lever 42 upward to indicate the user intends to turn right. The digital radio and microcontroller 46 may consequentially emit a signal to a signaling device. The signaling device may then illuminate in a fashion which signals the vehicle will be turning right. When the signaling device is illuminating, the indicator lights 48 may illuminate.

FIG. 4 illustrates a side, representational view of an example remote controlled signal bulb 60. The remote controlled signal bulb 60 may be sized as a standard size automotive bulb lamp. The remote controlled signal bulb 60 may fit into and draw power from an existing socket on the antique vehicle. It may be desirable that the remote controlled signal bulb 60 be configured such that no modification to the socket is required for installation. Thus, the remote controlled signal bulb 60 may replace an already existing, tail light bulb, turn signal bulb, brake light, or the like on the vehicle.

The example remote control signal bulb 60 includes a bulb housing 64 which includes a base 63 and a bulb 65. The example remote control signal bulb 60 includes an embedded radio unit and IC (which are representationally depicted as electronic chips in the example embodiment) inside the bulb housing 64 in the example embodiment. The radio unit and IC may include a microprocessor controller. This allows the remote controlled signal bulb 60 to be controlled as part of a system (see, for example, system 10 of FIG. 1). The remote controlled signal bulb 60 may be controlled such that it changes brightness, color, or flash rate. For example, in one embodiment the remote controlled signal bulb 60 may be used as a tail light which could be made to brighten and/or blink such that it may also be functional as a turn signal. The radio and IC may be included on a traditional rigid PCB and/or flexible multi layer PCB arranged in a helical or non-planar shape. In the example embodiment, the remote control signal bulb 60 contains a stacked PCB consisting of a number of layers 62a, 62b, and 62c. This may allow for the fitment of an entire remote control, oscillation circuit, and antenna into the available volume of a traditional automotive tail light bulb.

In some embodiments, remote control signal bulbs 60 may include an adapter 69 (not shown). The adapter 69 may be a configuration adapter. The adapter 69 may, for example, be a voltage adapter which allows a remote control signal bulb 60 to be used with a voltage other than that for which the circuitry of the remote control signal bulb 60 was designed. The adapter 69 may, for example, be a socket adapter and interface with the remote control signal bulb 60 such that it connects to different pinouts of the remote control signal bulb 60 depending on the voltage. Alternatively, there may be multiple embodiments of remote control signal bulbs 60 with circuitry configured for various voltages and adapters 69 may not be necessary. Additionally, there may be remote control signal bulb 60 embodiments for regular polarity automotive sockets and reversed polarity automotive sockets. In some embodiments, an adapter 69 may be used to allow a remote control signal bulb 60 to be used in the opposite polarity socket. In other embodiments, the adapter 69 may not be a physical component, but rather implemented in software such that the remote control signal bulb may be configured, in situ, to work in a variety of sockets. In some embodiments there may be different embodiments of remote control signal bulbs 60 for different type of mounting interfaces. Alternatively, this may also be accomplished by means of an adapter 69.

In some embodiments, the remote control signal bulb 60 may include a radio receiver. In other embodiments, it may be desirable that the remote control signal bulb 60 include a transceiver. This may be desirable because it would allow the remote control signal bulb 60 to communicate with other components of a system. For instance, the remote control signal bulb 60 may send low battery and other status/informational or acknowledgement messages to a controller if equipped with a transceiver. Additionally, a transceiver would allow the remote control signal bulb 60 to function as a relay to other signals in a system.

The remote control signal bulb 60 may include a radio unit which operates in an ISM band, for example, the 2.4 GHz ISM band. This may be desirable because of the worldwide availability of these spectrums. The radio technology may be a 802.15.4 Zigbee, Bluetooth, MiWi stack, etc. Additionally, the small antenna size of such a radio may also be desirable.

The radio IC used may perform packet checking and data acknowledgement to ensure signal receipt. Each radio IC may perform decoding and encoding of a unique identifier or multiple unique identifiers (each system component may broadcast its own unique identifier and/or a unique identifier of an intended recipient when communicating). Pairing of controllers and signals (e.g. association of each component's unique identifier with other system components) may be done during manufacturing. In some embodiments, a radio IC may only execute commands included in a command signal if the command signal also includes an expected unique identifier. In some embodiments, a radio IC may only execute commands included in a command signal if the command signal includes a plurality of expected unique identifiers. For example, a first expected unique identifier may be associated with a system controller 12 (see FIG. 1) with which the remote control signal bulb 60 has been paired. A second expected unique identifier may be associated with the remote controlled signal bulb 60.

The radio IC may also monitor for system faults to provide assurance of proper function or indication of faults to the user. The radio IC may have custom programmed firmware. Such firmware may include features like a unique identifier. This unique identifier may be a unique digital serial number and/or unique device ID. The unique identifier may help to discourage theft and may be used for identification purposes during communication. Firmware may be updated by the manufacturer or other personnel if necessary.

A lighting element, which in the example embodiment is a bank of high power LEDs 66, may be included to provide the desired amount of lighting. Additionally, the lighting element may be made to oscillate or pulse between an on and off state at a desired rate or in desired intervals. A lighting element may be brightened when desired. In some embodiments, only some of the light sources in a lighting element may illuminate at one time. In some embodiments, different light sources of a lighting element may be illuminated in order to produce a desired color of light, a variable intensity, or sequential signal. These functions may furthermore be coordinated with other signaling devices in a system such that, for example, desired sets or groupings of signals turn on and off in a predetermined relation to one another (e.g. simultaneous, opposite phase, etc.). Thus, the remote controlled signal bulb 60 may be “universal” for use as one or more of a turn, marker, tail, brake, reverse, or any other desired signal. Additionally, the remote controlled signal bulb may include multiple such functionalities. For example, the remote control signal bulb may function as a headlight, and when needed light an LED 66 of a different color such that it also functions as a directional.

It may be desirable that the lighting element utilize LEDs 66 for a number of reasons including but not limited to, increasing light output while keeping a small form factor, power consumption, and/or having a long usage lifetime for the lighting element. LEDs 66 provide greatly increased luminosity when compared to factory equipped 6V bulbs, providing the output of a standard filament bulb but at a fraction of the energy use.

In embodiments which include LEDs 66, the LEDs may, for example, be 100 lm OSRAM Dragon Plus (available from OSRAM Sylvania of 100 Endicott Street, Danvers Mass.) LEDs. Additionally, in some embodiments dispersion lenses may also be included as a part of the lighting element to ensure that light is projected in a desired fashion.

In an example where the remote controlled signal bulb 60 is included in a larger system, the remote controlled signal bulb 60 may be controlled by a remote controller such as the controller 40 shown and described in relation to FIG. 3. In some embodiments, the remote controlled signal bulb 60 may act as a repeater of a signal to another device (such as an additional brake light or other signals) also included in the same system.

An advantage of this remote controlled signal bulb 60 is that it can add a variety of functionalities (e.g. turn signal, brake, marker, and/or tail light functions) to an existing bulb socket on the vehicle. This may be particularly desirable when that socket did not have those functions when the car was produced. In many cases, a vehicle operator may combine one or more remote controlled signal bulb 60 with one or more removable signal (see FIG. 5). This may, for example, be done if the vehicle has tail lights in the rear, but no pre-existing sockets for signals in the front.

The remote controlled signal bulb 60 shown in FIG. 4 includes electrical contacts 68. The electrical contacts 68 may allow the remote control signal bulb 60 to draw power from the existing electrical system of an automobile. The housing 64 of the remote controlled signal bulb 60 may include a threaded or coupling portion (not shown) to allow the remote controlled signal bulb 60 to be coupled into a pre-existing bulb socket on an automobile.

As shown, the remote control signal bulb 60 may include a sensor 67. The sensor 67 may include one or more of the following, but is not limited to: one or more of an ambient light sensor, temperature sensor, inertial sensor, and/or proximity sensor. Embodiments including a sensor 67 will be further described later in the specification.

FIG. 5 illustrates an exploded perspective view of a remote controlled signal unit 80. In some embodiments, the signal unit 80 may be self powered and independent from the vehicle. The signal unit 80 may include a coupling element which allows the signal unit 80 to be removably coupled to the vehicle.

The example signal unit 80 utilizes a magnet 82 for the temporary attachment of the signal unit 80 to the vehicle. In some specific embodiments, the magnet 82 may be a powerful neodymium rare earth magnet with a pull force of about 70-90 pounds. In embodiments including a magnet 82, the face of the magnet 82 which would be most proximal to a vehicle when the signal unit 80 is coupled to the vehicle may be covered with a scratch preventing member (not shown). The scratch preventing member may help to minimize the risk of scratching that may result from coupling and uncoupling of a signal unit 80 from a vehicle or other surface. The scratch preventing member may be a foam, elastomeric, felt, fabric, or the like pad which is affixed to the magnet 82. The scratch preventing member may be sufficiently thick so as to effectively minimize scratch potential, but not so thick as to preclude the magnet 82 from securely holding the signal unit 80 onto a vehicle or other surface.

In other embodiments, a signal unit 80 may include different coupling elements. For example, a signal unit 80 may include a suction cup or the like. In some embodiments, the signal unit 80 may include a bracket which may be bolted or otherwise coupled to an automobile. In some embodiments, the signal unit 80 may include an adhesive backing or the like which may be used to attach the signal unit 80 to an automobile. It may be desirable that the means by which the signal unit 80 is attached does not require alteration or modification to be done to an automobile or other surface.

The example signal unit 80 shown in FIG. 5, includes a lighting element 84. In the specific example embodiment shown in FIG. 5, the lighting element 84 includes a light source which is a bank of high output LED lamps 92. The LED lamps 92 may be fitted with dispersion lenses to produce the desired brightness in a diffused manner, while using very little current. The LED lamps 92 may, for example, be 100 lm OSRAM Dragon Plus LEDs (available from OSRAM Sylvania of 100 Endicott Street, Danvers Mass.). The LED lamps 92 may be similar to and be controlled similar to the LEDs 66 described in relation to FIG. 4.

In some embodiments, the lighting element 84 may have a light output which conforms to government defined brightness standards, levels, or requirements. For example, the lighting element 84 may be configured to meet USDOT requirements.

Additionally, the lighting element 84 may include a reflector element 85 arranged to efficiently project light from the light source of the lighting element 84. The lighting element 84 may be covered or enclosed by a lens, shroud, or cover 94. The cover 94 may be transparent and clear in some embodiments. In other embodiments, the cover 94 may be tinted a desired color (e.g. red if the signal unit 80 is to be used as a brake light).

The example signal unit 80 shown in FIG. 5 also includes a digital radio and IC 88. The digital radio and IC 88 may, for example, include a radio unit and a microprocessor controller. The digital radio and IC 88 may be used for actuation of the lighting element 84, fault detection, and repeating of signals to other system components. In some embodiments, the digital radio unit of the digital radio and IC 88 may operate in an ISM band (e.g. the 2.4 GHz band). The digital radio and IC 88 may be similar to the radio IC 62 shown and described in relation to FIG. 4.

The example signal unit 80 includes a level 86 attached to the signal unit 80. The level 86 may be used for purposes of alignment on a vehicle. The level 86 may be any suitable variety of level. In some embodiments, the level 86 may be a bubble level. In other embodiments, the level 86 may be a smart level.

As shown, the signal unit 80 also includes an on-board power source 90. The on-board power source 90 may supply power to the signal unit 80. The on-board power source 90 may be a battery, such as a rechargeable battery. The on-board power source 90 may be a battery with a high energy density such as a lithium-ion battery. In some specific embodiments, a high capacity, approximately 3 amp hour rechargeable lithium-ion battery may be used. In some embodiments, the on-board power source 90 may be sufficient to power the signal unit 80 for about 500 hours of driving time per charge when used under normal driving conditions.

The signal unit 80 can be removed temporarily when desired for the showing of the vehicle as “original”. The signal unit 80 may be placed anywhere on a vehicle. For example, the signal unit 80 may be attached on the front, rear, or a high-mount stop lamp position. Furthermore, the signal unit 80 may act as a turn, tail, reverse, running, brake light, etc. depending on signals from a system controller unit (or other system component). The signal unit 80 may be configured to be of a small size and weight. In some specific embodiments, the signal unit 80 may have a footprint of approximately 60 mm×60 mm×60 mm. This may make the signal unit 80 an unobtrusive light source which may easily be removed and stowed. In some embodiments, or for some signal units 80 the dimensions may differ. For example, a high mount stop signal may be dimensioned as a long bar.

In various embodiments, the signal unit 80 may include one or more sensors. For example the signal unit 80 may include an ambient light sensor, temperature sensor, inertial sensor, proximity sensor, as discussed in relation to other embodiments described herein. Other sensors may also be included in the signal unit 80.

FIG. 6 depicts an illustration of a number of signal units 80 in place on a vehicle 100. The example vehicle 100 was not factory equipped with running lights/turn signals on its front end. As shown, the signal units 80 are coupled (e.g. magnetically) to the front of the vehicle 100 in a location where it may be desirable to have running lights and/or turn signals. Thus the vehicle 100 may be equipped with such signals without any modification to the vehicle 100 itself. This may provide added safety. The signal units 80 may, however, be easily and quickly removed when the vehicle 100 is not being driven. This may be desirable when the vehicle 100 is being displayed for show or for judging, for instance, since having a non-stock vehicle may be undesirable on such occasions.

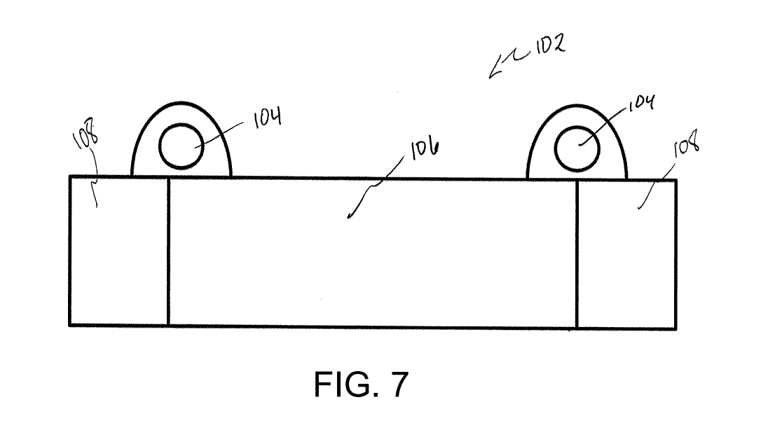

FIG. 7 depicts a representational embodiment of another example signal light. The example light shown in FIG. 7 is a high mount signal 102. Such a high mount signal 102 may be placed roughly at the midline of the rear of a vehicle. In some embodiments, a high mount signal 102 (or any other signals included in a signaling device system) may be configured to be mounted inside of the vehicle such that the signal is visible to other drivers or individuals. As shown, the example embodiment of the high mount signal 102 includes two suction cups 104 which may allow the high mount signal 102 to be coupled to the rear window of the vehicle. A high mount signal 102 may include one or more lighting element similar to the signal unit 80 depicted in FIG. 5. Additionally, the high mount signal 102 may include an onboard power source such as a battery and various control and remote communications circuitry similar to the embodiment described in FIG. 5. The high mount signal 102 may be included in a signaling device system and controlled similarly to as described herein with respect to other embodiments.

As shown, the high mount signal 102 may include a main signal 106. The main signal 106 may for example provide a brake light functionality such that the high mount signal 102 may act as a high mount brake light. As shown, the high mount signal 102 is also shaped as a long bar similar to a high mount brake light. In some embodiments, a high mount signal 102 may also include one or more independently controllable sections 108. Such independently controllable sections 108 may be controlled individually and need not necessarily illuminate in the same manner as the main signal 106. Such independently controllable sections 108 allow the high mount signal 102 to be a multiple functionality signal. For example, the independently controllable sections 108 may be configured to illuminate as directional signals in some embodiments of high mount signals 102 including at least one independently controllable section 108. In some specific embodiments, independently controllable sections 108 may be added to a high mount signal 102 in modular fashion as desired. Alternatively, there may be multiple different high mount signals 102 each providing a desired signal functionality.

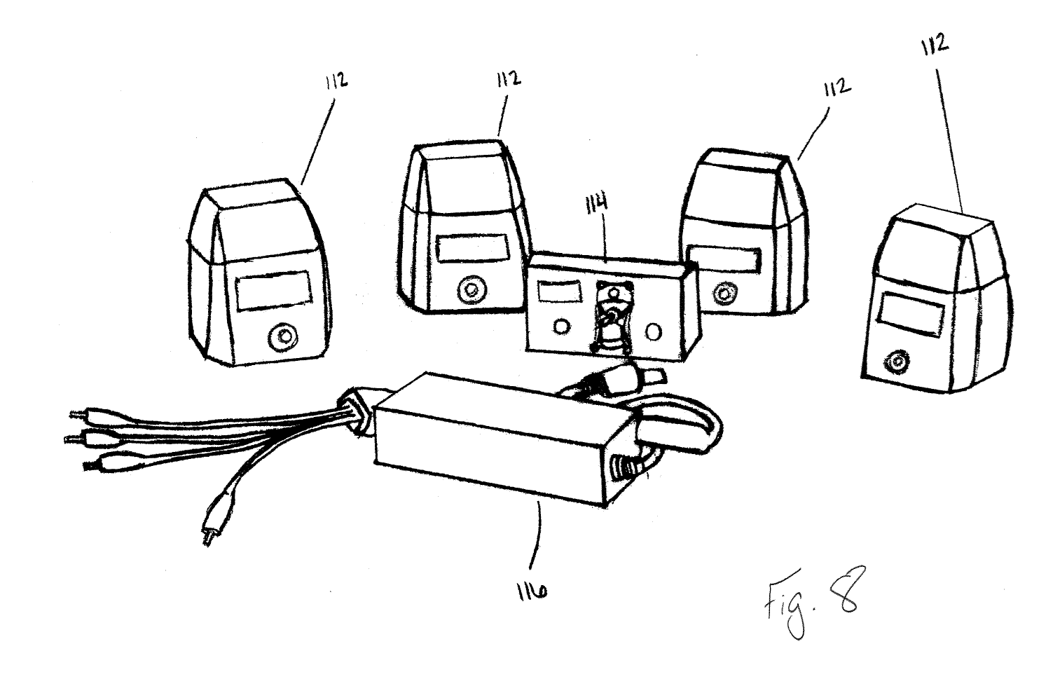

FIG. 8 depicts a specific example embodiment of a system 110. The system 110 may be a specific example of the system 10 described in relation to FIG. 1. As shown, the system 110 includes a number of signaling devices 112. The signaling devices 112 will be further described later in the specification. The system 110 includes a controller 114. The controller 114 may be used to control the function of the signaling devices 112. The controller 114 will be further described later in the specification. In the example embodiment, both the signaling devices 112 and controller 114 are battery powered and communicate wirelessly. The system 110 additionally includes a charger 116. The charger 116 may be used to charge the signaling devices 112 and the controller 114. In some embodiments, the charger 116 may draw power from a cigarette lighter of a vehicle.

As shown, various cabling 118 is depicted accompanying the charger 116. The cabling 118 may be used to communicate power to system 110 components which require charging. As shown, the cabling 118 may be configured such that a number of system 110 components may be charged simultaneously by a single charger 116.

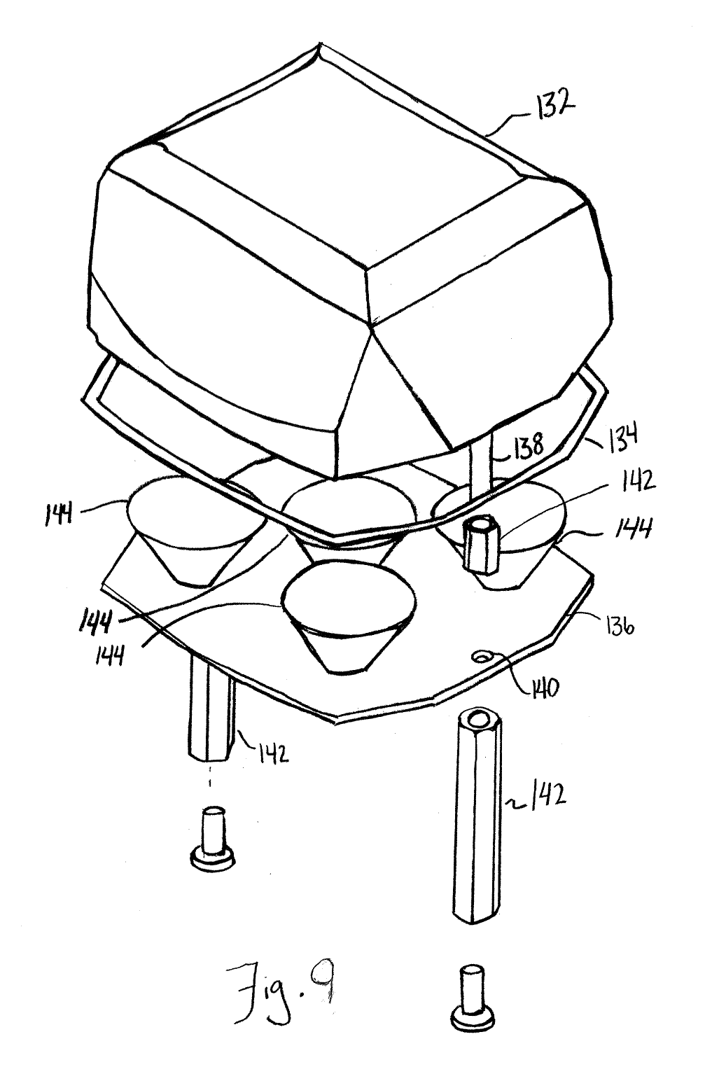

FIG. 9 depicts a perspective, exploded view of a specific example lighting element 130 of a signaling device. The lighting element 130 may be used as part of the signaling devices 112 shown in FIG. 8. As shown, the lighting element 130 includes a cover member 132. The cover member 132 may be transparent and/or tinted a desired color. The cover member 132 may in some embodiments be relatively smooth. In other embodiments, surfaces of the cover member 132 may be textured to encourage light to be emitted in a more diffused manner. The cover member 132 may be injection molded in some embodiments. A gasket 134 is also depicted in FIG. 9. The gasket 134 may be attached to the cover member 132. The gasket 134 may, in some embodiments, be affixed to the cover member 132 using glue, epoxy, or an adhesive. The gasket 134 may help prevent ingress of liquid into the lighting element 130. This may be desirable in embodiments where the lighting element 130 may be used in an outdoor environment.

The cover member 132 may attach to a PCB and LED assembly 136. In the example embodiment, the cover member 132 includes studs 138 which may extend through holes 140 in the PCB and LED assembly 136. In the example embodiment only one stud 138 and hole 140 are visible. The studs 138 may in some embodiments be threaded such that the PCB and LED assembly 136 may be retained between two cooperatively threaded standoffs 142 for each stud 138. Additionally, this threaded interface may be used to compress the gasket 134 between the cover member 132 and PCB and LED assembly 136. This may be desirable because it may allow a more robust seal to be created when the lighting element 130 is assembled. The standoffs 142 may also help in coupling of the lighting element to another assembly, for example, the signal body 150 shown and described in FIG. 10.

As shown, the PCB and LED assembly 136 may include a number of light sources 144. The light source 144 may be any suitable color or number of colors. The light sources 144 shown in FIG. 9 are LEDs fitted with dispersion or reflector elements. In such embodiments, these elements may be attached to the PCB using a suitable fixative. In some embodiments, glue, adhesive, or epoxy may, for example be used. The PCB and LED assembly 136 may also include other components. For example, a radio and IC microcontroller may be included on the PCB and LED assembly 136. This may allow the lighting element 130 to be remote controlled, communicate status information, detect faults, etc.

FIG. 10 depicts a perspective, exploded view of a specific example signal body 150 of a signaling device. The signal body 150 may be a part of the signaling devices 112 shown and described in relation to FIG. 8. A lighting element, such as the lighting element 130 shown and described in relation to FIG. 9 may be attached to the signal body 150 during assembly to create a signaling device.

As shown, the signal body 150 includes a housing 152. The housing 152 may be any suitable housing. The housing 152 may be hollow and may be sized such that it may contain or attach to other components of a signaling device. The housing 152 may be made of a lightweight, durable material, which may, in some embodiments, be plastic or metal. In some embodiments, it may be desirable that the housing 152 be made of a material which will stand up to use in an outdoor environment. As shown, in some embodiments, a product label 154 may be affixed to the housing 152.

The signal body 150 may include an electrical input cable assembly 156 as shown. In some embodiments, the electrical input cable assembly 156 may include a DC power jack, cover for the DC power jack and associated wiring to other components (e.g. rechargeable batteries 158). The electrical input cable assembly 156 may receive power from a charger 116 (see FIG. 8).

The signal body 150 includes two batteries 158 in the example embodiment shown in FIG. 10. In other embodiments, there may only be one battery 158 or more than two batteries 158. The batteries 158 may be rechargeable batteries. It may be desirable that the batteries 158 have a high energy density to allow for a long usage life on a single charge if the batteries 158 are rechargeable.

The signal body 150 may include a power switch assembly 160. The power switch assembly 160 may include wiring and a switch. Any suitable variety of switch may be used. The switch may be used to turn the signaling device on and off.

A magnet 162 is also included as a part of the example signal body 150. In some embodiments, there may be multiple magnets 162. The magnet 162 may be attached to the housing 152. The magnet 162 may allow the signal body 150 to be coupled to a surface, such as an automobile body. In some embodiments, the magnet 162 may be substantially “o” shaped such that a fastener 164 may pass through the magnet 162 and fasten it to the housing 152. The example signal body 150 also includes a nut 166 and washer 168 to help retain the magnet 162 on the housing 152. A scratch preventing member 170 is also included in the example embodiment. The scratch preventing member 170 may be a rubber, felt, fabric, elastomeric, etc. type pad which may be attached to the magnet 162. In some embodiments, a face of the scratch preventing member 170 may be covered in adhesive to facilitate attachment to the magnet 162. In other embodiments, the scratch preventing member 170 may be attached to the magnet 162 by any other suitable means. In some specific embodiments, the magnet 162 may be a 70-90 1b pull force neodymium magnet. Some embodiments may not use a magnet 162. Some embodiments may bolt onto a bracket or the like. Some embodiments may use suction to attach the signal body 150 to the desired surface. In such embodiments, a suction cup may replace the magnet 162 shown in FIG. 10.

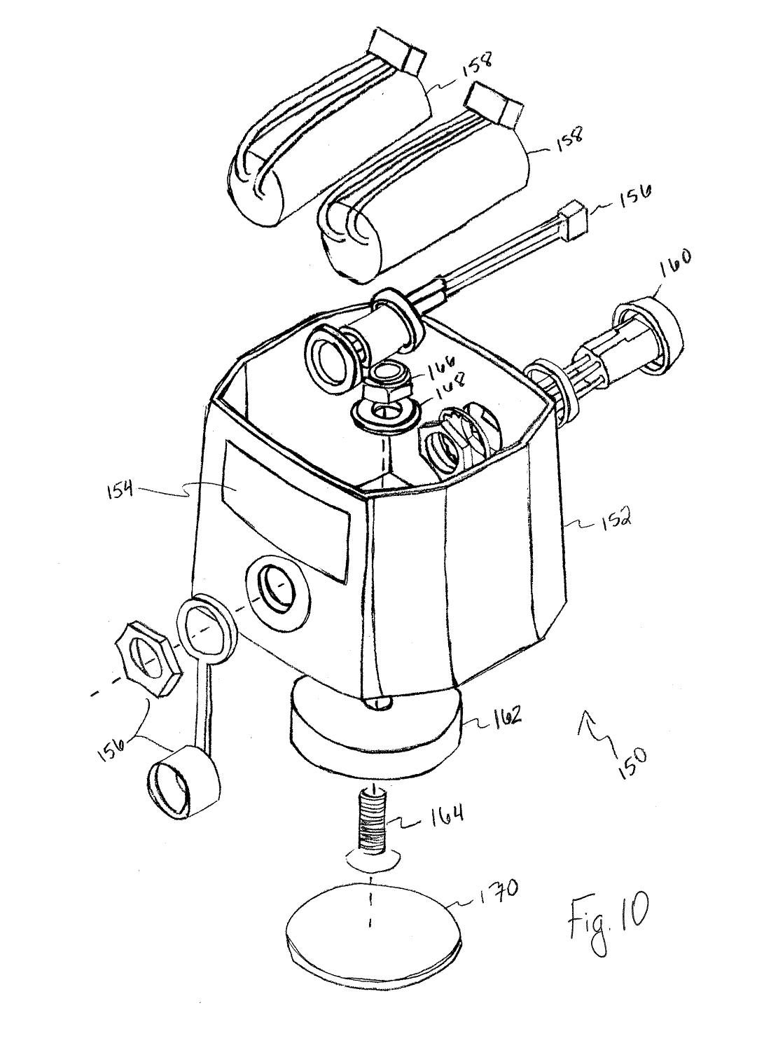

FIG. 11 depicts a bottom, perspective view of a specific embodiment of a signaling device 112. As shown, a lighting element 130 and signal body 150 have been coupled together to form the signaling device 112. The lighting element 130 and signal body 150 may be coupled together via any suitable means. In some embodiments, a gasket (not shown) may be included between the lighting element 130 and signal body 150 to help prevent liquid ingress into the signaling device 112.

As shown, a scratch preventing member 170 has been attached to the magnet 162 in the example embodiment. Additionally, present on the bottom of the signaling device 112 is a placement indicator 180. A placement indicator 180 may be included to indicate to a user where the signaling device 112 should go. For example, if the signaling device 112 is to be used on an automobile, the placement indicator 180 may indicate that the signaling device ought to be placed on a specific portion of a car (e.g. right, rear portion of the automobile). In the example embodiment, the placement indicator 180 is a text indicator. In some embodiments, the placement indicator 180 may be a graphic indicator or other indicator. In some embodiments, the placement indicator 180 may be adhesive backed and attached to the signal indicator by means of the adhesive backing. In some embodiments, the placement indicator 180 may be included as part of a mold for the signal body 150.

Also shown in FIG. 11 is another information indicator 182. The information indicator may be used to convey other information to a user. The information indicator 182 may be used to convey warnings, instructions, or any other desired information to the user. The information indicator may be included as part of the mold 150 for the signal body 150, may be attached via adhesive or other fixative, etc.

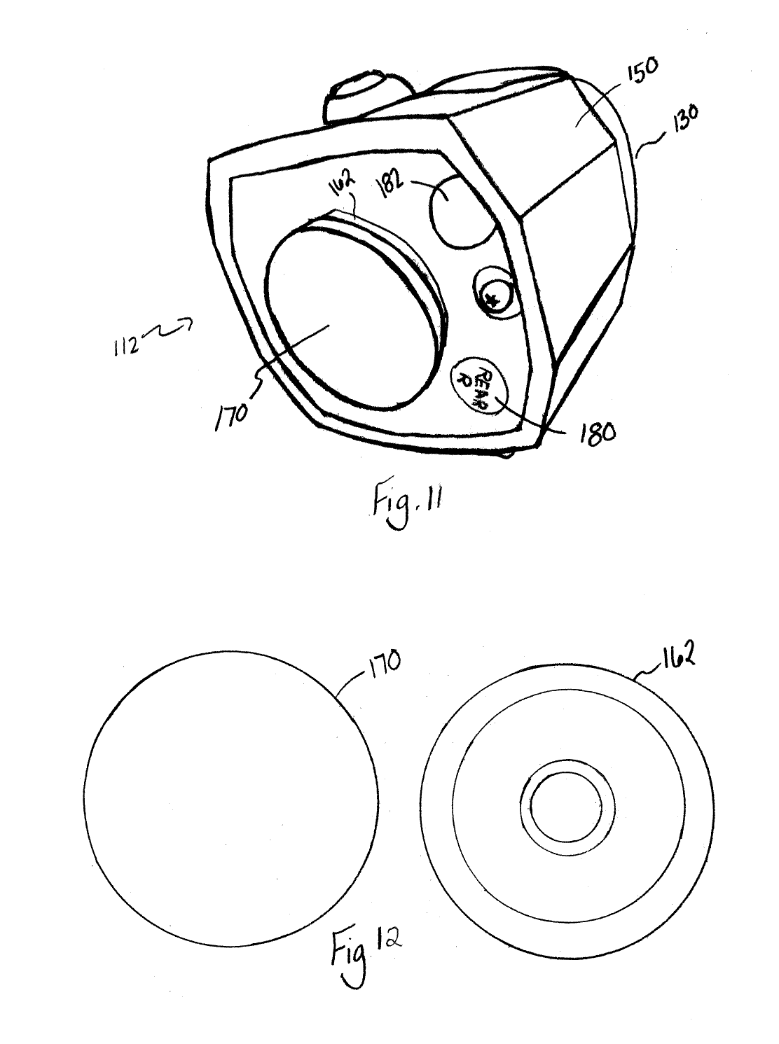

FIG. 12 depicts an example embodiment of a magnet 162 and scratch preventing member 170. The magnet 162 and scratch preventing member 170 are substantially as described above. In some embodiments, a signaling device may come with additional magnets 162 and scratch preventing members 170. These may be used in applications where a signaling device needs to be attached to a wood, plastic, or other material which would not lend well to magnetic coupling. In such embodiments, one magnet 162 and scratch prevention member 170 pair may be placed on one side of the surface. The signaling device, which has its own magnet 162 scratch prevention member 170 pair, may then be placed on the other side of the surface. The attraction of the magnets 162 will hold the signaling device in place on the surface.

In some embodiments, one or more magnet 162 and scratch preventing member 170 may be used to attach a system controller 114 (see, for example, FIG. 14) to a surface as well. For example, magnets 162 and scratch preventing members 170 may be used to attach a controller 114 to a convenient portion of an automobile such that the controller 114 does not move about while driving.

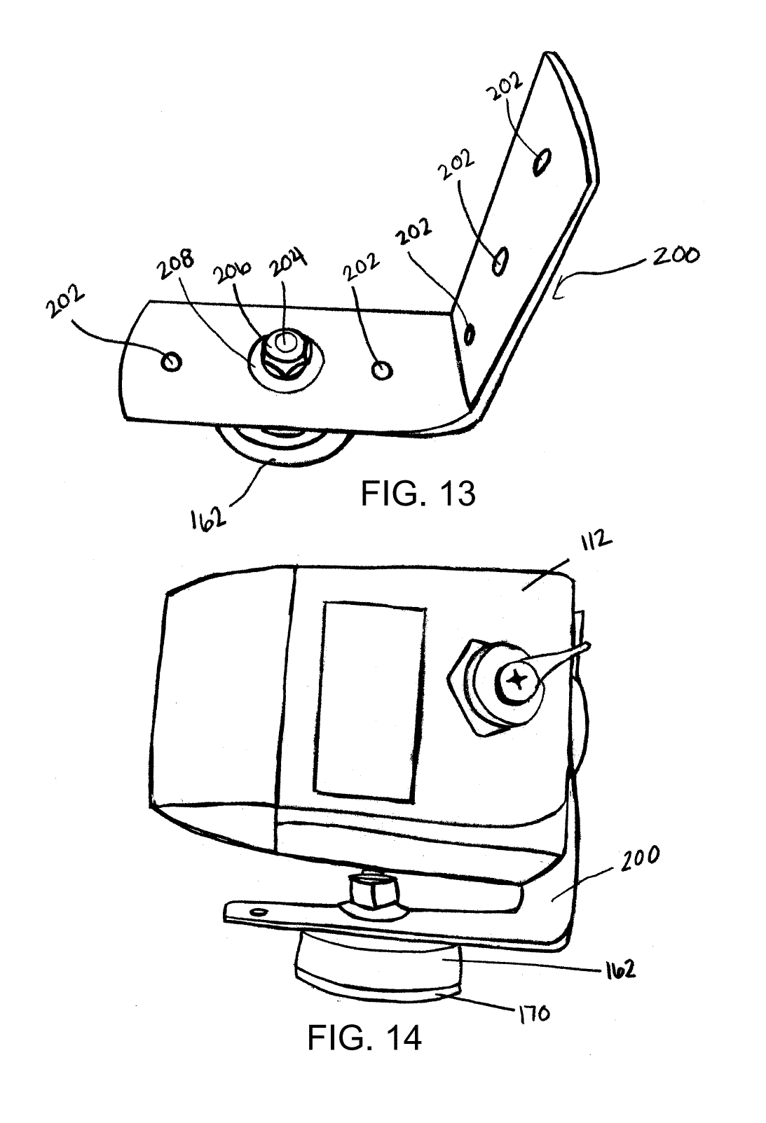

FIG. 13 depicts an example embodiment of a bracket 200 which may be used to attach a signaling device to an object. As shown, the bracket 200 includes a number of holes 202. A magnet 162 may be coupled onto the bracket 200 through one of the holes 202. In the example embodiment, a fastener 204 which passes through the magnet 162 is used to retain the magnet 162 on the bracket 200. A nut 206 and washer 208 also aid in retention of the magnet 162 on the bracket 200. The bracket 200 may be made of a strong, durable material which may be suitable for outdoor use.

The bracket 200 may be attached to any desired suitable surface by means of the magnet 162. Referring now also to FIG. 14, a signaling device 112 may also be attached to the bracket 200. This may be accomplished through the use of a magnet on the signaling device 112. In other embodiments, the signaling device 112 may be attached to the bracket 200 via fasteners which pass through the holes 202 of the bracket 200. The bracket 200 may thus allow a signaling device 112 to be attached to a surface without needing to alter or damage that surface. This may be particularly desirable in automotive applications where such alteration or damage may ruin the stock nature of the automobile and negatively affect its value. As shown best in FIG. 14 a scratch prevention member 170 may be placed on the bracket 200 magnet 162 to enhance protection of the attachment surface.

In some embodiments, a bumper 210 may be included on the bracket 200. In such embodiments, the bumper 210 may be made of a soft, non-scratching material. The bumper 210 may serve to protect an attachment surface from accidentally being bumped and scratched with a hard metal bracket 200. In some embodiments, the bumper 210 may be over molded onto the bracket 200. In other embodiments, the bumper 210 may be a separate piece which is dimensioned such that it may be pulled over the bracket 200 to receive the bracket 200. In some embodiments, the bumper 210 may only encompass the edges or select portions of the edges of the bracket 200.

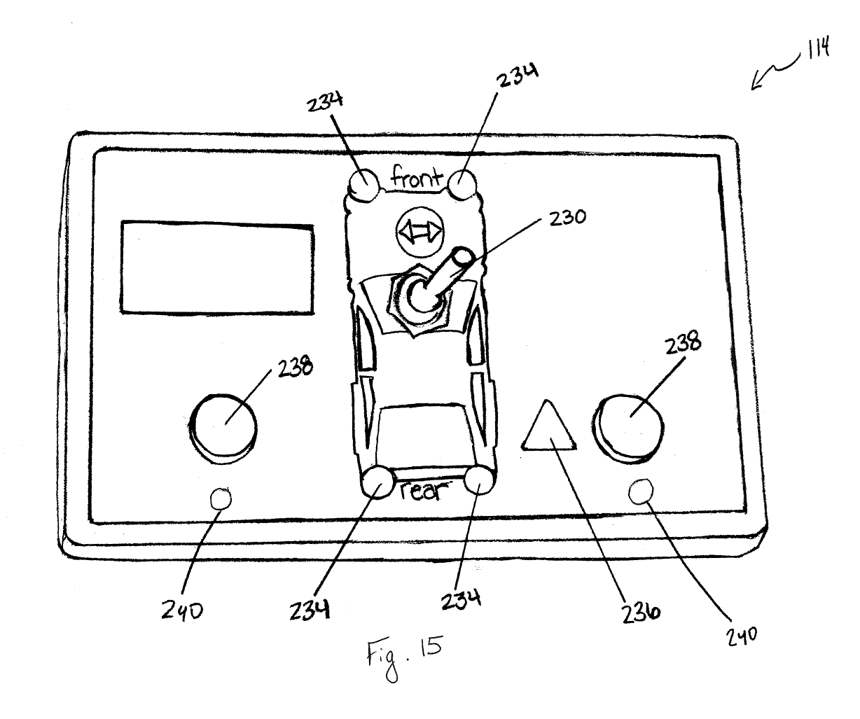

FIG. 15 depicts a specific embodiment of a system controller 114. The controller 114 may be used to control operation or one or more signaling devices included in a signaling system. Signaling devices which may be controlled by such a controller 114 may include, but are not limited to, those described herein. As shown, the controller 114 may control the system wirelessly, for example, using RF. In some specific embodiments, the controller 114 may operate in an ISM band and may utilize a communication stack such as Zigbee, MiWi, Bluetooth, etc. The controller 114 may contain various transmitters, antennas, and any other circuitry needed to facilitate wireless system control.

As shown, the example controller 114 includes an actuator which in the example embodiment is a switch 230. The switch 230 may be any suitable type of switch in various embodiments. In the example embodiment, the switch 230 is a manual toggle switch. The switch 230 may be used to control signaling devices included in a signal system. For example, to turn right, an operator may displace the switch 230 to the right. This may cause the controller 114 to command the signaling devices on the right of the vehicle to flash signaling the impending right hand turn. Once the operator has completed the turn, the operator may return the switch 230 to the center position to turn off the directional signals. In other embodiments, the switch 230 may differ. For example, in sonic embodiments, the switch 230 may mimic a conventional turn signal lever similar to the vehicle signal lever 42 shown and described in relation to FIG. 3.

In the example embodiment, the controller 114 also includes a representational graphic 232. This graphic 232 may approximate the shape of an automobile in some embodiments. As shown, the graphic 232 includes illuminated signal indicators 234. The location of the illuminated signal indicators 234 on the graphic 232 corresponds roughly to conventional signal placement on an automobile. In some embodiments, the illuminated signal indicators 234 may light in a manner which reflects how signals in the signaling system are currently functioning. For example, the illuminated signal indicators 234 on the right hand side of the graphic 232 may blink when signals on the right hand side of the car are blinking. Thus, the illuminated signal indicators 234 may provide visual feedback and status information to a user. In some specific embodiments, the illuminated signal indicators 234 may be LEDs.

Additionally, in some embodiments, the controller 114 may provide audible feedback to a user as well. For instance, the controller 114 may produce audible feedback which mimics the sound generated by a relay in a conventional turn signaling system. This sound may be produced only when the signals are blinking (i.e. as would occur with a conventional turn signal) and may provide auditory feedback to a user so that the user knows the signals are functioning when expected.

Also shown in FIG. 15 is a hazard light indicator 236. The hazard light indicator 236 may illuminate when the signals in the signaling system are lighting as hazard lights. The hazard light indicator 236 may also be accompanied by audible feedback so that a user knows that the signals are functioning as expected.

Two buttons 238 are included on the example controller 114. The buttons 238 may control additional functions of signals in a signaling system. In some embodiments a differing number of buttons 238 may be included. The buttons 238 may for example control when signals are constantly illuminated (e.g. as running lights), when signals illuminate as hazard lights, when signals illuminate as brakes, when signals illuminate as reverse lights, when signals operate as high beams, when signals illuminate to signal an impending turn, when signals illuminate to indicate a lane change (i.e. blink a predetermined number of times and automatically stop), etc.

In some embodiments, a button 238 may have different behaviors depending upon the user input received. For example, a button 238 may have two different assigned functions. The first function may require only a momentary button 238 depression to initiate. The second function may require the button 238 to be depressed for a predetermined duration or time to initiate. Double tapping within a predetermined time duration may also, in some embodiments, may be used by a user to differentiate between one and another function.

The controller 114 includes additional indicator lights 240 as well. The additional indicator lights 240 may be used to convey various information to a user. In some embodiments, the additional indicator lights 240 may convey status and fault information to a user. In other embodiments, the additional indicator lights 240 may convey other information to a user. For example, the additional indicator lights 240 may convey low battery information, etc. to a user. The additional indicator lights 240 may be accompanied by auditory feedback as well in embodiments including a speaker.

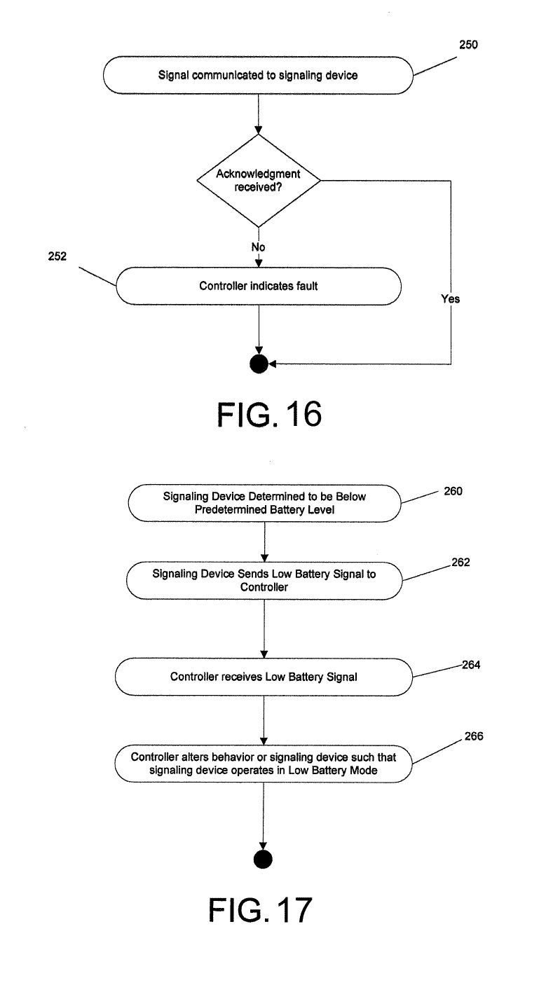

FIG. 16 depicts a flowchart detailing a number of example steps which may be used to identify a fault condition in a signaling device system. As shown, in step 250, a controller of the system may send a signal (e.g. a command) to a signaling device. As mentioned elsewhere herein, this may occur in response to a user actuating an actuator on the controller. When the signaling device receives the signal, the signaling device may send an acknowledgment to the controller that the signal has been received. Acknowledgements may include additional information as well (e.g. battery level, status information, fault information, etc.) In some embodiments, the controller may wait for a predetermined period of time after sending the signal for an acknowledgment message to be received. Depending upon the protocol used by the embodiment, the acknowledgment message may be passive or active. In a passive scheme, the controller may listen to hear the message re-broadcast to other signaling devices for example. In the active scheme a dedicated acknowledgment message may be sent to the controller from the signaling device. Additionally, in some embodiments, multiple acknowledgment messages may need to be received. For example, if the signal is relayed by multiple signaling devices, there may be an acknowledgment sent from each signaling device and an acknowledgment message indicating that the signal reached its final destination.

If the controller receives an acknowledgement message, the system may continue functioning normally. In scenarios where there may be multiple acknowledgement messages, the controller may need to receive each of the acknowledgment messages. In the event that an acknowledgment message is not received (e.g. within a predetermined time window), the controller may indicate a fault in step 252. Alternatively or additionally, in some embodiments an acknowledgement message may include an indication that a fault or other condition requiring a user's attention is present. Such an acknowledgement message would be treated by a controller similarly to a scenario in which an expected acknowledgement messages is not received.

A fault condition may be communicated to the user in any of a variety of ways. For example, the controller may issue an audible alarm, fault tone or sequence, or other indication of the fault condition. Additionally, or instead, in some embodiments, the controller may light one or more indicator lights to indicate the presence of the fault condition. In embodiments where a light may be lit in response to a fault condition, the light may be lit in a color which the user may associate with a fault or caution condition (e.g. red). Additionally, the light may blink to help ensure the condition is brought to the user's attention.

In some embodiments, the controller may attempt to resend the signal a predetermined number of times before proceeding to step 252. If the resend attempts are met with a lack of acknowledgment then the controller may indicate the fault condition.

FIG. 17 depicts a flowchart detailing a number of steps which may be used to identify and respond to a low battery condition of a signaling device in a signaling device system. As shown, the example flowchart begins with a low battery condition in a signaling device being detected in step 260. In various embodiments, a signaling device may periodically check its battery level and report back to a system controller. Such a status report may be sent as part of an acknowledgement message in some embodiments. Additionally, in some embodiments, a controller may query various signaling devices in the system for a battery level update. This may for example occur nominally on a preset schedule. A low battery level condition may, for example, be determined to exist in the event that the battery level falls below a predetermined threshold. In some embodiments, trend data for battery usage and life may also be taken into account when determining a low battery condition exists.

After a low battery level condition has been detected in step 260, the signaling device may send a signal indicating the low battery level to the controller in step 262. The controller may then receive this signal in step 264. After receiving a low battery signal, the controller may alter the behavior of the signaling device such that the signaling device operates in a low battery mode in step 256. The controller may also provide an indication to the user that a low battery condition exists.

A low battery mode may help to conserve remaining battery and extend the amount of remaining drive time before the signaling device runs out of power. In a low battery mode, duty cycle of the signaling device lighting element(s) may, for example, be altered. The signaling device may be controlled such that it does not operate as brightly as during normal operation. Alternatively, a signaling device may operate without reduced brightness, but for shorter periods of time (e.g. blink on for a shortened period of time if used as a directional). In some embodiments, in a low battery mode, the signaling device may blink or oscillate at a lower frequency. The signaling device may, in some embodiments, be pulsed at high frequency such that it appears to be substantially continuously light. Additionally, non-essential communication (e.g. test pings or the like) between the signaling device and the controller may be limited or suspended.

In some embodiments, there may be multiple low battery level thresholds. For example, there may be a low battery level condition which causes a low battery mode to be initiated as described above. In addition, there may be a warning level threshold. This threshold may be higher than the low battery level condition threshold and may cause a “charge signaling device” indicator light or the like on the controller to indicate that a signaling device needs charging. Additionally, there may be one or more battery level threshold set lower than the low battery level condition threshold to indicate the signaling device will soon run out of battery. The controller may modify behavior of a signaling device in a manner which would conserve power and extend the amount of remaining drive time as each threshold is crossed in some embodiments.

A flowchart similar to that shown in FIG. 17 may be used to relay and react to various other conditions of a signaling device. For example, if a signaling device detects a fault condition, the signaling device may relay the information to a system controller. The system controller may then receive the information from the signaling device and take appropriate action. For some faults, this may involve the controller altering the operation of the signaling device. Additionally, this may involve signaling the existence of the fault condition as described elsewhere herein.

In some embodiments, a component of the system (e.g. a controller) may be configured to trend battery usage over time and use such trend data to predict battery life or behavior. This trend data may incorporate data from a number of sensors on each signaling device in the system. For example, the trend data may use temperature data in combination with battery level data over time to better predict how much run time the battery of a signaling device may support. Additionally, usage of such historical trending data may help to determine if a battery may die before it would otherwise be expected. For example, if the battery has historically failed at 25% depletion (e.g. the battery has a bad cell) such historical trend data may be used to more accurately predict when the battery will fail in the future. Additionally, such trend data may be used to inform a user that a battery in a signaling device should be replaced. In some embodiments, a component of a signaling device system (e.g. the controller) may analyze trend data upon system start-up and inform a user of any potential issues and/or set one or more low battery level threshold.

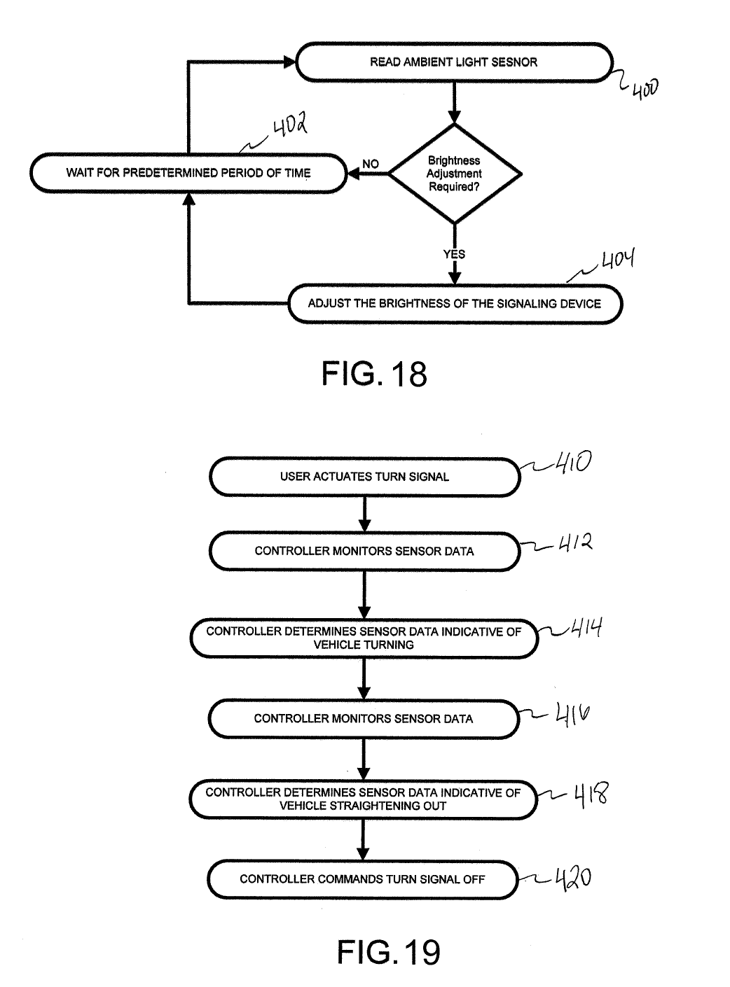

FIG. 18 depicts a flowchart which details a number of example steps which may be used to adjust the light output of a signaling device. It may be desirable to adjust such light output depending on ambient lighting conditions. For example, during the day, it may be desirable that a signaling device illuminate more brightly than it would during the nighttime. Additionally, by adjusting the brightness of a signaling device, the signaling device may more efficiently make use of battery power. This may help to extend the number of hours that a battery may power a signaling device on a single charge.

As shown, in step 400 a component of a signaling device system may read the output of an ambient light sensor. The ambient light sensor may be any suitable variety of ambient light sensor. In some embodiments, an ambient light sensor may be included in each signaling device. A determination may then be made as to whether the brightness of the signaling device should be altered. If the reading does not indicate that the brightness of the sensor should be altered, step 402 may be performed. In step 402, a wait period may elapse. The wait period may be a predetermined amount of time. After step 402 has completed, step 400 may be performed again and another ambient light sensor reading may be made.

In the event that it is determined that the brightness of the signaling device should be altered, step 404 may be performed. In step 404, the brightness of the signaling device may be adjusted. After performing step 404, step 402 may be performed as described above. In some embodiments, the signaling device may alter in brightness in a proportional relationship to the amount of ambient light detected. A signaling device may brighten as a greater amount of ambient light is detected and dim as the amount of ambient light decreases. In other embodiments, determination that the signaling device brightness should be altered may involve a reading from the ambient light sensor crossing a predetermined threshold. Such a predetermined threshold may, for example demarcate between readings which would be indicative of a brighter and a darker condition (e.g. day and night). In other embodiments, there may be multiple thresholds, which when crossed, may cause the brightness of a signaling device to be adjusted. In a specific example, if the reading from the ambient light sensor suggests that ambient lighting conditions have transitioned to a darker ambient light environment, the signaling device may be caused to decrease its light output or dim. In the event that ambient lighting conditions become brighter, the signaling device may be caused to brighten. In still other embodiments, the signaling device may adjust without monitoring ambient lighting conditions with an ambient light sensor. For example, in some embodiments, a signaling device may adjust its brightness or light output based on a predetermined schedule.

The determination as to whether or not the brightness of the signaling device should be adjusted may be made using a processor in the signaling device itself in some embodiments. In other embodiments, a controller of the signaling device may include a processor which makes this determination. In such embodiments, ambient light sensor outputs may be transmitted to the controller. In some embodiments, these readings may be sent automatically on a predetermined schedule. In other embodiments, the controller may query signaling devices for such readings.

In some embodiments, additional steps may be performed before the brightness of a signaling device may be adjusted. For example, in some embodiments, readings from other ambient light sensors included in signaling devices may be compared before a signaling device's light output may be adjusted. In the event that the data from each ambient light sensor does not agree within a predetermined range, an error may be generated and conveyed to the user via the controller. In some embodiments, readings from each ambient light sensor in a signaling device system may, for example, be averaged together to determine whether and how much to adjust the brightness of signaling devices within a signaling device system.

FIG. 19 depicts a flowchart detailing a number of example steps which may be used to automatically cancel or turn off a turn signal in a signaling device system. It may be desirable that a turn signal automatically turn off after a vehicle has completed a turn. This may help to ensure that the signal turns off even if a user forgets to switch off the signal. It may also help to ensure that the battery of a signaling device is not unnecessarily drawn down if a user forgets to turn off the signal. In some embodiments, the signal may be automatically cancelled by monitoring sensor data from one or more sensor (e.g. accelerometer, gyrometer, etc.) and determining when a user has completed a turn and straightened out the vehicle.

As shown, in step 410, a user may actuate a turn signal in a signaling device system. This may cause a signaling device to illuminate so as to indicate the impending turn as described elsewhere herein. A component of the system may monitor sensor data in step 412. In the example flowchart, the controller is shown as monitoring sensor data, though in alternate embodiments, a processor on a signaling device may also or instead monitor sensor data. The sensor(s) monitored may be one or more inertial sensor such as an accelerometer or gyrometer. The data may be monitored for sensor outputs which would be produced as the vehicle is turning. In some embodiments, the data may be monitored for sensor outputs which would be produced when the vehicle is turning in the direction associated with the illuminated turn signal. In step 414, the controller may determine that the sensor data is indicative that the vehicle is turning. After such a determination, the controller may continue to monitor sensor data in step 416. The controller may monitor sensor data for sensor outputs which would be produced as the user straightens the vehicle out and the turn has been completed. In step 418, the controller may determine that the vehicle has straightened out. Upon determination that the vehicle has been straightened out, the controller may command the turn signal to turn off in step 420. In some embodiments, the controller may require that sensor data indicate the vehicle has straightened out for a predetermined amount of time or number of readings before commanding the turn signal off in step 420.

In some embodiments, the turn signal may be automatically turned off without input from sensors included in a signaling device system. In such embodiments, for example, a signaling device may be turned off after a predetermined number of flashes. In other embodiments, a signaling device may be turned off after a predetermined period of time (e.g. 25 seconds).

When a signaling device is about to automatically turn off or when a signaling device automatically turns off, a signaling device system may notify the user. For example, in some embodiments, a controller in the signaling device system may provide an indicator to indicate that a turn signal is automatically being turned off. Such an indicator may be an audible noise or tone, light, any other suitable indicator, or combination thereof. Additionally, in various embodiments, the user may be able to manually turn off the signal at any time.

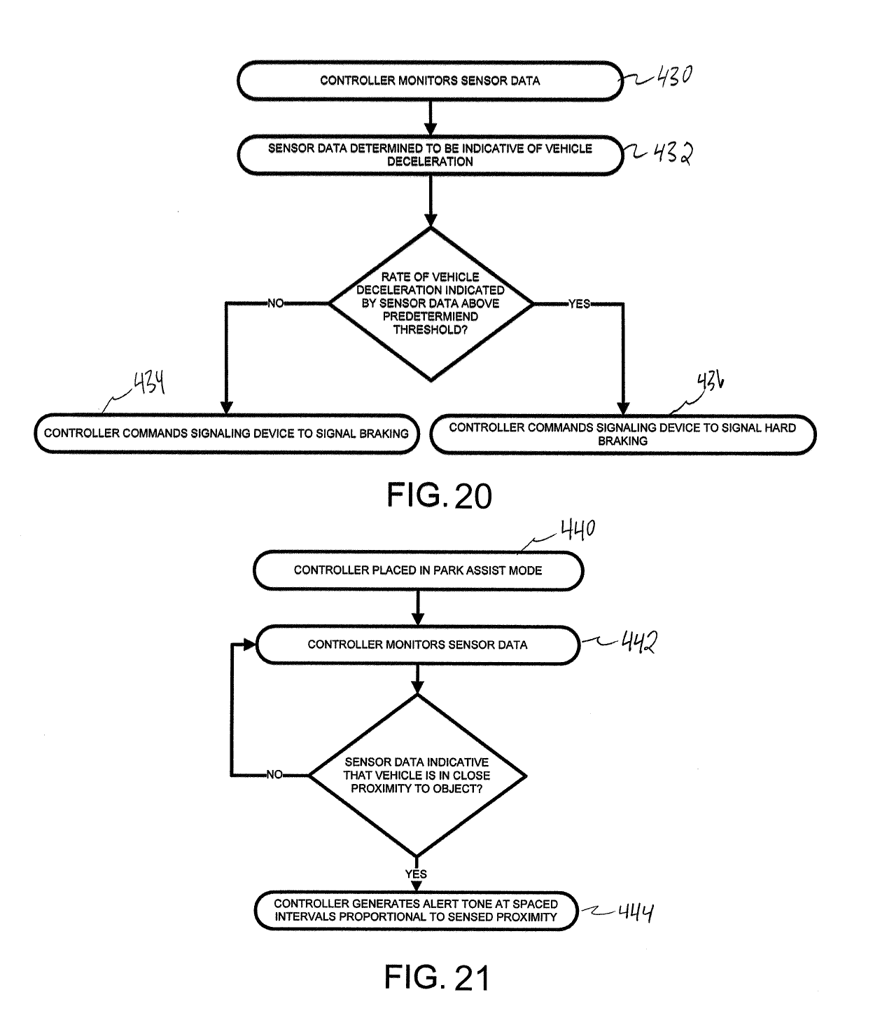

FIG. 20 depicts a flowchart detailing a number of example steps which may be used to automatically illuminate a brake light when a vehicle is decelerating (e.g. the brake is being applied, during engine braking, etc.). Additionally, the flowchart details example steps which may be used to signal a hard brake in the event that the vehicle is decelerating a fast rate. In some embodiments, such signal may be automatically commanded by monitoring sensor data from one or more sensor (e.g. accelerometer, gyrometer, etc.) and determining when and/or at what rate the vehicle is decelerating.

As shown, in step 430, a component of the system may monitor sensor data. In the example flowchart, the controller is shown as monitoring sensor data, though in alternate embodiments, a processor on a signaling device or other system component may also or instead monitor sensor data. The sensor(s) monitored may be one or more inertial sensor such as an accelerometer or gyrometer. The data may be monitored for sensor outputs which would be produced as the vehicle is decelerating. In step 432, the controller may determine that the sensor data is indicative of vehicle deceleration.

In some embodiments, a determination may be made about the rate of vehicle deceleration indicated by the sensor data. In some embodiments, the controller may determine whether the rate of deceleration is above a predetermined threshold. If it is determined that the rate of deceleration is not above the predetermined threshold, step 434 may be performed. In step 434, the controller may command the appropriate signaling devices to illuminate in a manner which would indicate that the vehicle is braking. In the event that the rate of deceleration is above the predetermined threshold, step 436 may be performed. In step 436, the controller may command the appropriate signaling devices in the signaling device system to indicate a hard braking condition exists. In such a condition, the illuminated signaling devices may illuminate in a manner which would convey to other users that the vehicle is decelerating at a fast rate. This may, for example, involve quickly flashing, strobing, or blinking the brake signals in the signaling device system. Additionally, such signals may illuminate more brightly when indicating a hard brake in some embodiments.

In some embodiments, different steps or additional logic may be employed before signaling devices within a signaling device system illuminate to indicate the vehicle is braking or decelerating. For example, before performing step 434, in some embodiments, a determination may be made to check that the rate of deceleration is not below a predetermined threshold. If the rate of deceleration is below that threshold, in some embodiments, the controller may not command the brake signal to illuminate. This may help to prevent a situation in which signaling devices in a signaling device system illuminate as brakes while the vehicle is decelerating slowly while coasting or the like.

FIG. 21 depicts a flowchart which details a number of example steps that may be used to provide feedback related to the proximity of an object or objects while a vehicle is being maneuvered. This may, for example, be desirable to help prevent a collision with an object while parking the vehicle or navigating the vehicle through tight spaces. In some embodiments, a proximity sensor (e.g. ultrasonic sensor, IR sensor, or any other suitable sensor) included in a signaling device system may provide sensor data that may be used to determine proximity to an object or objects. Such sensors may, for example, be included in signaling devices of the system or may be a stand-alone component which may be attached to the vehicle and communicate with other system components.

As shown, in step 440 the controller of the signaling device system may be placed in a park assist mode. In some embodiments, the controller need not be placed in a park assist mode. When placed in the park assist mode, the controller (or another component of a signaling device system in alternate embodiments) may proceed to step 442 in which the controller may monitor sensor data. As mentioned above, the monitored sensor data may be generated by one or a number of proximity sensors included in a signaling device system. In specific embodiments where the proximity sensor is an ultrasonic sensor or IR sensor, the sensor may output a signal. The sensor may provide data indicative of a characteristic of the output signal reflected back to the sensor. In some specific examples, as the sensor is moved closer to an object, the strength of the reflected signal may be caused increase and the strength of the reflected signal may be monitored. Thus the data may be used to determine proximity of an object while the vehicle is parking or maneuvering in a tight space. Additionally, in some embodiments, when the controller is placed in park assist mode, appropriate signaling devices in a signaling device system may be commanded to illuminate as parking lights.

The controller may determine whether the sensor data is indicative that the vehicle is in close proximity to an object. This determination may involve checking to determine if sensor data from any of the proximity sensors included in a signaling device system is indicative of an object being in close proximity. In the event that any proximity sensor generates data indicative of an object in close proximity, step 444 may be performed. In step 444, the controller may indicate that there is an object in close proximity. In various embodiments, this indication may be provided by lighting a light on the controller, generating an audible noise, any other suitable indication, or combination of indications. In some specific embodiments, including that shown in FIG. 21, the controller may generate an audible alert tone at spaced intervals. The intervals may be spaced proportionally to sensed proximity. As the vehicle gets closer to an object the time period between alert tones may shorten. In some embodiments, when the vehicle gets within a predetermined sensed distance (e.g. 4 inches), the alert tone may become continuous. Additionally or instead, in some embodiments, the alert tone may change in pitch in proportion to the sensed proximity to an object. For example, the alert tone may increase in pitch as the vehicle comes closer to an object.

As mentioned above, in some embodiments, one or more signaling device (e.g. any of those described above) may be paired with and controlled by a wireless sensing controller which may include a transmitter or transceiver. In other embodiments, such a sensing controller need not necessarily be wireless. Such a sensing controller may function in tandem with or independent of a main controller for a signaling device. For example, such a sensing controller may indicate to a main controller that a signal should be enabled and then the main controller may then enable that signal. If the sensing controller is independent of the main controller, the sensing controller may directly command one or more signal in a signaling system to be enabled or disabled. In some embodiments, a sensing controller may be used without a main controller. Additionally, similar to embodiments described above, a sensing controller may be readily removable or non-permanently attached. This may be accomplished magnetically, via suction, clips, or any other suitable means. Such a sensing controller may be used without any modification to the vehicle which would hurt its collector value.

In some embodiments, a sensing controller may be configured to detect a condition of interest which would indicate that a signaling device should be illuminated. For example, in some embodiments, a sensing controller may detect the actuation of a brake pedal or directional lever and send an appropriate command based upon that detection. Though the following discussion describes embodiments for usage with a brake pedal, these embodiments may be easily modified for use in detecting directional lever actuation or other conditions of interest.

In other embodiments, a sensing controller may be configured to detect deceleration of a vehicle and send a command to a signaling device causing the signaling device to illuminate as a brake light. In other embodiments, a sensing controller may detect ambient lighting conditions and cause headlight or running light signals to illuminate or may cause signaling devices to adjust light output or brightness. In other embodiments, a sensing controller may detect current flow through a wire to a light socket on the automobile and act as a repeater which causes other signaling devices on an automobile to illuminate cooperatively. This may be desirable because old automotive lighting may be relatively dim and/or less than optimally placed. It may be desirable to detect, via the current in the wiring, whether a light is acting as a brake light. Upon determination that the light is acting as a brake light, the sensing controller may send a command to bright LED signaling devices in a signaling device system to illuminate such that the signal is displayed in more pronounced and visible fashion.

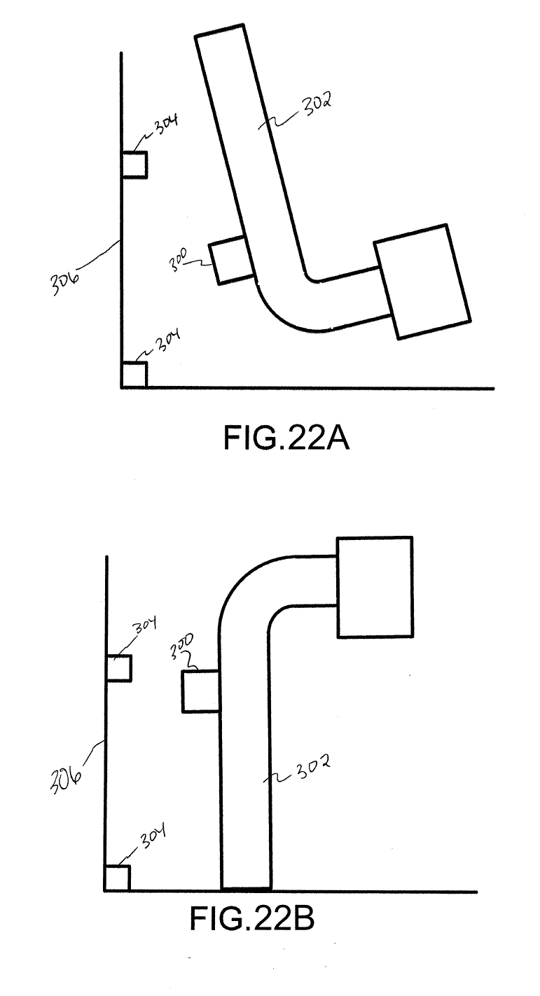

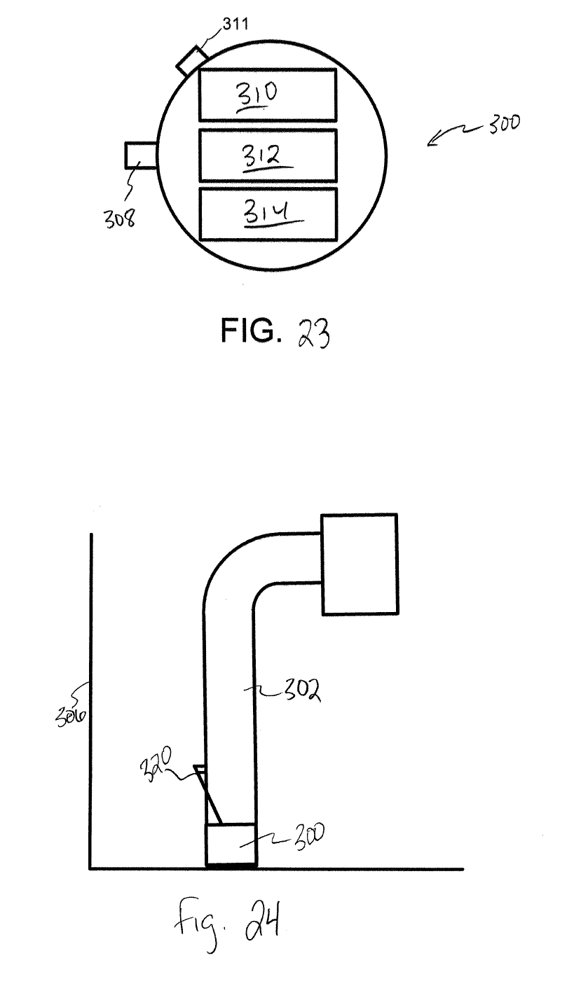

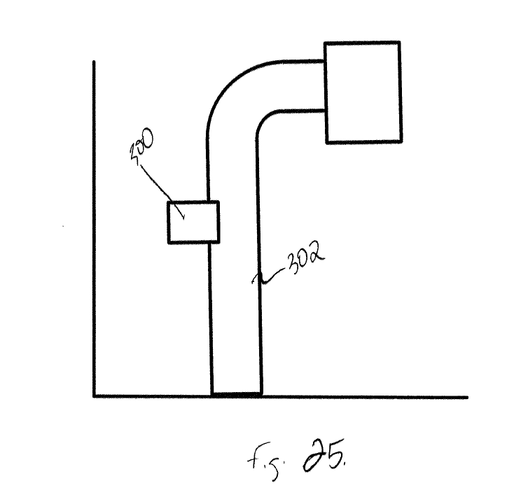

FIG. 22A and FIG. 22B depict representational example embodiments of a sensing controller 300 which may be configured to detect brake pedal 302 actuation and send a command to a signaling device in response to detection of brake pedal 302 actuation. FIG. 22A and FIG. 22B show embodiments where the brake pedal 302 of the automobile is hanging above and extending from the floor of the vehicle respectively. In the example embodiments, the sensing controller 300 is wireless. As shown, the vehicle operator may place the wireless sensing controller 302 which may include for example, a magnetic sensor on the brake pedal 302. Any suitable, preferably non-permanent attachment means may be used. In embodiments such as that shown in FIG. 22A and FIG. 22B where the sensing controller 300 includes a magnetic sensor, one or more magnets 304 are placed on the vehicle chassis 306 along the path of a brake pedal 302 arm travel. The magnets 304 may be stationary with respect to the vehicle. In other embodiments, the sensing controller 300 may not include a magnetic sensor or may include other or additional types of sensors. For example, in various embodiments, a sensing controller 300 may include a gyroscopic sensor, accelerometer, optical sensor, potentiometer, any suitable variety of encoder, rangefinder, or any other suitable position, angle, displacement, distance, acceleration, or speed sensor.

Referring now also to FIG. 23, a representational top down view of the sensing controller 300 depicted in FIG. 22A and FIG. 22B is shown. Once the sensing controller 300 and any other needed components are installed, the operator may then place the sensing controller 300 in a “learn” mode. In the example embodiment, this may involve the operator pushing a “learn” button 308 on the sensing controller 300. In other embodiments, a “learn” mode need not be entered via a button press, but rather any other suitable user interaction. After depression of the “learn” button 308, the operator then manually pushes the brake pedal 302, so that the brake pedal 302 arm moves along its predictable path of travel.

Any sensors on the sensor unit 310 of the sensing controller 300 (e.g. gyroscopic, magnetometer, accelerometer, any others described above, or any suitable sensor which would be obvious to one skilled in the art) may all record the movement of the pedal 302 and pedal arm while it is being depressed. That is, sensor data may be recorded as the operator manually depresses the brake pedal 302. A microprocessor which may also be included on the sensor unit 310 then may process the data from the sensor or combined sensors and create an algorithm for predicting future forward and backward movement of the brake pedal 302.

Once this “learned” state is achieved, an LED light 311 included as part of the sensing controller 300 may flash, or otherwise indicate to the user that the device has “learned” the travel of the pedal 302 and arm and hence, expected sensor outputs indicative of the pressing of the brake pedal 302. An operator may place a signaling device to be controlled by the sensing controller 300 on the vehicle. The signaling device may, for example, be any wireless unit such as any of those described herein. As described above, these units may use high power LED lighting, a radio, battery, a magnet or suction device, and a microprocessor that will respond to a radio signal being sent out by the sensing controller 300 on the brake pedal 302 and illuminate as a brake lamp, warning following vehicles.

As shown in FIG. 23, the sensing controller 300 may include other additional components. In the example embodiment shown in FIG. 23 the sensing controller 300 includes a radio transceiver 312. The radio transceiver 312 may send a command to one or more signaling device controlled by the sensing controller 300. For example, in some embodiments, a radio transceiver 312 may command a left and right brake light and a high mount brake light in various embodiments. In some embodiments, such communication may make use of unique identifiers as described previously. In some embodiments, the sensing controller 300 need not communicate directly with the controlled signaling devices. In such embodiments, the command may be communicated to main controller which may then propagate a command to the appropriate signaling devices. In embodiments where the sensing controller 300 is not wireless, the sensing controller 300 may not include a radio transceiver 312. Additionally, in some embodiments, the radio in a sensing controller 300 need not necessarily be a transceiver. In some embodiments, the radio unit may be a transmitter unit.

The sensing controller 300 shown in FIG. 23 may also include a battery 314. The battery 314 may be used to power the sensing controller 300. This battery 314 may be a rechargeable or replaceable power source. In embodiments where the battery 314 is rechargeable, the auxiliary controller 300 may additionally include a charge port for connection to a charger. In embodiments where a sensing controller 300 is not wireless, the sensing controller 300 may not include a battery 314.

FIG. 24 depicts another representational example embodiment of a sensing controller 300 which is similar to that depicted in FIG. 22A and FIG. 22B. In the example embodiment in FIG. 24, the sensing controller 300 includes a potentiometer. The potentiometer arm 320 is visible in FIG. 24. The sensing controller 300 may be attached to the vehicle in a location which would allow the brake pedal 302 to displace the potentiometer arm 320 as the brake pedal 302 is displaced. As the potentiometer arm 320 is displaced with brake pedal 302 movement, the wiper of the potentiometer may be caused to slide across the resistive element of the potentiometer. The change in resistance may be used to determine the brake pedal 302 is being depressed by the user. It may also be desirable that the potentiometer arm 320 be held against the brake pedal 302. In some embodiments, the potentiometer arm 320 may be non-permanently attached to the brake pedal 302 via magnets or another suitable attachment means.

Alternatively, the potentiometer arm 320 may be biased into contact with the brake pedal 302 by means of a bias member included in a sensing controller 300.

FIG. 25 depicts another representational embodiment of an example sensing controller 300. In the example embodiment shown in FIG. 25 the sensing controller 300 may include one or more inertial sensor such as an accelerometer or accelerometers. Additionally or instead a gyroscopic sensor may be included in the sensing controller 300 in some embodiments. Such sensors may be used to detect the orientation of a brake pedal 302 and the change in orientation of the brake pedal 302 as the brake pedal 302 is depressed by the user.

In some embodiments, data from such sensors in a sensing controller 300 may be compared to data from other similar sensors in a main controller or other component of a signaling device system. Such other sensors may, for example, be stationary with respect to the vehicle. This comparison may, for example, be used to detect when a brake pedal 302 is being depressed and when the vehicle is decelerating. Consequentially, such a comparison may allow signaling devices on a vehicle to function as engine braking indicators. Such a comparison may also be useful to indicate braking on a vehicle such as a forklift where braking is often accomplished simply by removing engine power.

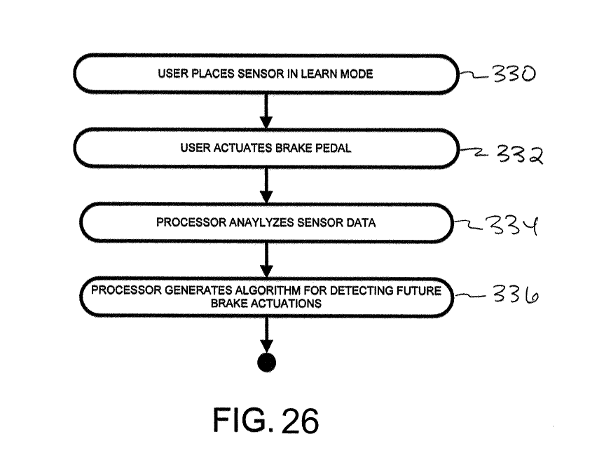

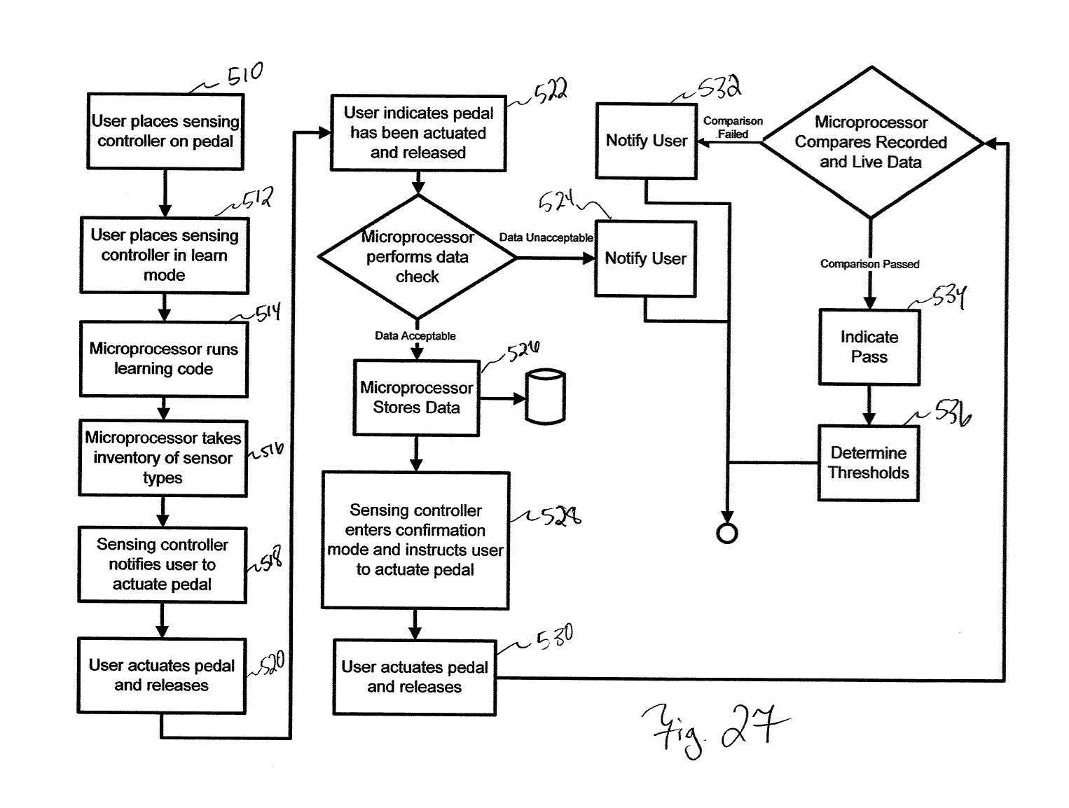

FIG. 26 depicts a flowchart detailing a number of example steps which may be used by a sensing controller to “learn” to detect a condition which would indicate that a signaling device should be illuminated. In the specific example flowchart, the steps detailed are for “learning” how to detect a brake pedal has been actuated. Similar steps may be used by a sensing controller to detect other conditions. As shown, in step 330, the user may place a sensing controller in a “learn” mode. This may, for example, involve depressing a “learn” button on the sensing controller in some embodiments. After placing the sensing controller in a “learn” mode, the sensing controller may in some embodiments provide feedback to the user to confirm that the sensing controller has entered the “learn” mode. For example, this may involve lighting an LED or other light source and/or generating audible feedback.

After a sensing controller has been placed in “learn” mode, the user may actuate the brake pedal in step 332. This may involve moving the brake pedal from an “at rest” position, through its travel path to a fully depressed position, and then back to the “at rest” position. As the brake pedal is actuated, the sensor(s) in the sensing controller may collect data. In step 334, this data may be processed by a processor included in the sensing controller. The processor may then generate an algorithm for detecting future brake pedal actuations in step 336. This may involve determining various thresholds along the brake pedal actuation path or trajectory based upon the sensor data. For example, a slight pedal movement threshold may be determined, which may cause the sensing controller to wake up from a sleep mode and start analyzing data to determine if the vehicle operator is applying the brake. Additionally, a brake applied threshold may be determined. This threshold may cause the sensing controller to command that one or more signaling device in the system illuminate as a brake light. As the data is processed, the processor may also define an at rest position and a fully extended position which may be useful in determining the thresholds and in detecting faults during operation. In some embodiments, the user may be required to actuate the brake pedal multiple times in the learn mode to provide multiple samples of data to the processor. In such embodiments step 334 may involve combining (e.g. averaging) the data samples together. Step 336 may then be performed on the combined sample data.

In the example embodiment, to indicate that the brake pedal actuation path was “learned” (i.e. steps 334 and 336 were successful) by the sensing controller, the sensing controller may provide feedback to the user. For example, this may involve lighting an LED or other light source and/or generating audible feedback. In alternative embodiments, the sensor data may be transmitted to another controller such as a main controller. In such embodiments, this main controller may perform steps 334 and 336.

FIG. 27 depicts a flowchart detailing a number of example steps which may be used by a sensing controller to “learn” to detect a condition which would indicate that a signaling device should be illuminated. In the specific example flowchart, the steps detailed are for “learning” how to detect a brake pedal has been actuated. Similar steps may be used by a sensing controller to detect other conditions. As shown, in step 510, a user may place a sensing controller on the brake pedal of the vehicle. The user may then place the sensing controller in a learn mode in step 512. This may, for example, be accomplished by pressing a button or the like. The sensing controller microprocessor may then run the code for the learning mode in step 514. Once the controller is in the learn mode, in step 516, the sensing controller may take an inventory of the sensor types in the system in some embodiments. If an expected sensor is not detected, or an unexpected sensor is detected, the sensing controller may signal a fault to notify the user. The sensing controller may then notify the user to actuate the brake pedal in step 518. At this point, a timeout counter may be initiated. This counter may be used to determine if a predetermined period of inactivity has elapsed without the sensor controller detecting any movement of the pedal. In the event that the timeout period elapses, the sensing controller may repeat step 518 or signal a fault to the user.

In step 520, the user may actuate and release the brake pedal. The user may then, in step 522 indicate that the pedal has been actuated and released. This may, for example, be done by pressing a button. In some embodiments, the button pressed may be the same button used to perform step 512. Once the microprocessor registers that the user has performed step 522, the microprocessor may then check the sensor data recorded during the brake pedal actuation. If the data is found to be unacceptable (e.g. data not received from all sensors or incomplete data received) the user may be notified in step 524. This notification may convey to the user that they are required to restart the calibration process. If the data is determined to be acceptable, the microprocessor may store the data in memory in step 526.

After storing the data, the sensing controller may enter a confirmation mode and instruct the user to again actuate the pedal in step 528. In step 530, the user may again actuate and release the pedal. The microprocessor may then compare the data stored in step 526 to the data produced in step 530. This comparison may determine whether the data from steps 526 and 530 are within a predetermined relationship with one another. For example, the comparison may detect whether the sensor outputs from steps 526 and 530 were similar or within a range of one another. This may be done to confirm that the learn data stored in step 526 is indeed representative of the travel of the brake pedal. In the event that the comparison fails, the user may be notified by the sensing controller in step 532. In the event that the comparison passes, the sensing controller may indicate that the comparison has passed in step 534. In some embodiments, the user may be required to perform step 530 multiple times and the data from each actuation and release may be compared to the data from step 526. In some embodiments, this data may also be used to create a historical data set for use in determining how much deviation may be expected from the stored data from step 526 during brake pedal actuations.

In step 536, the microprocessor may determine various thresholds used in detection of brake pedal actuation. Based on the data collected, the microprocessor may select a slight movement threshold which causes the sensing controller to wake up from a sleep mode. The microprocessor may also, for example, determine a brake applied threshold which, when crossed, cause the microprocessor to generate a command for signaling devices in the system to illuminate. During use, the microprocessor may analyze data from brake pedal actuations to adjust these threshold settings to optimized set points. Additionally, in this step, various conditions such as a pedal at rest condition and a pedal fully extended condition may be defined.

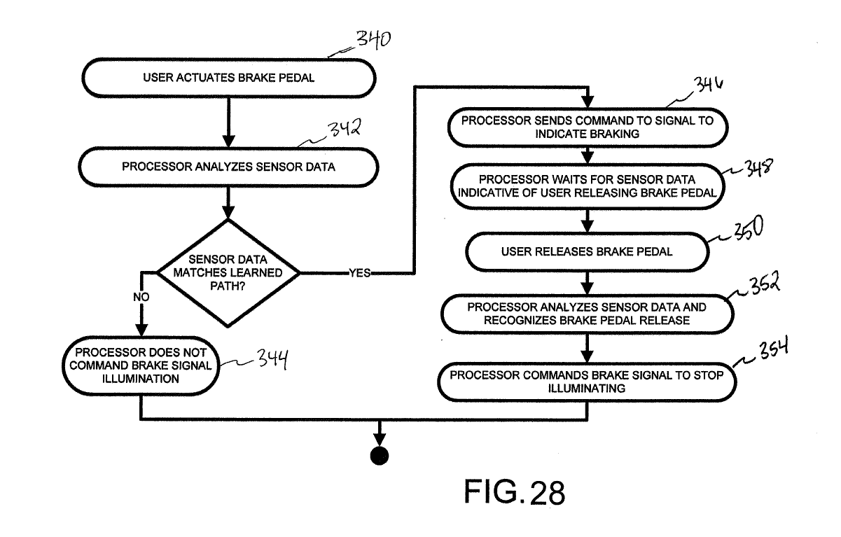

FIG. 28 depicts a flowchart detailing a number of example steps which may be used to detect a condition indicating a signaling device should be illuminated and to command one or more signaling device to illuminate as appropriate. In the example flowchart, the steps shown relate specifically to detecting and reacting to actuation of a brake pedal. Similar steps may be used by a sensing controller to detect and react to other conditions. It should be noted that the flowchart depicted in FIG. 28 begins after a sensing controller has “learned” how to detect the condition of interest. This may, for example, be accomplished by following steps similar to those described in relation to FIG. 26 or FIG. 27.

As shown, in step 340, the user may actuate the brake pedal of the vehicle. In step 342, sensor data from the sensing controller (and, in some embodiments, other sensors included in the system) may be analyzed. This data may, in some embodiments, be analyzed by a processor on the sensing controller. In other embodiments, the data may be communicated to another controller such as a main controller and a processor included in that controller may analyze the sensor data. The processor may then determine whether or not the sensor data is indicative of a condition of interest. In the example embodiment, the processor may determine if the sensor data indicates a match to the travel path of the brake pedal “learned” when the sensing controller was put through the “learn” mode.

In the event that the sensor data does not indicate that the condition of interest exists (e.g. the sensor data indicates the brake pedal was not depressed), the flowchart proceeds to step 344. In step 344, no command to illuminate a brake signal is generated. If the sensor data is indicative that the condition of interest exists, the flowchart may proceed to step 346. In step 346, the processor may send a command to a signal which instructs the signal to indicate that the vehicle is braking. The processor may then wait for sensor data indicative of the user releasing the brake pedal in step 348. In step 350, the user may release the brake pedal. In step 352, the processor may analyze the sensor data generated when the brake pedal was released and recognize that the brake pedal has been released. The processor may then, in step 354, issue a command to the signaling device(s) to stop illuminating to indicate that the vehicle is braking.

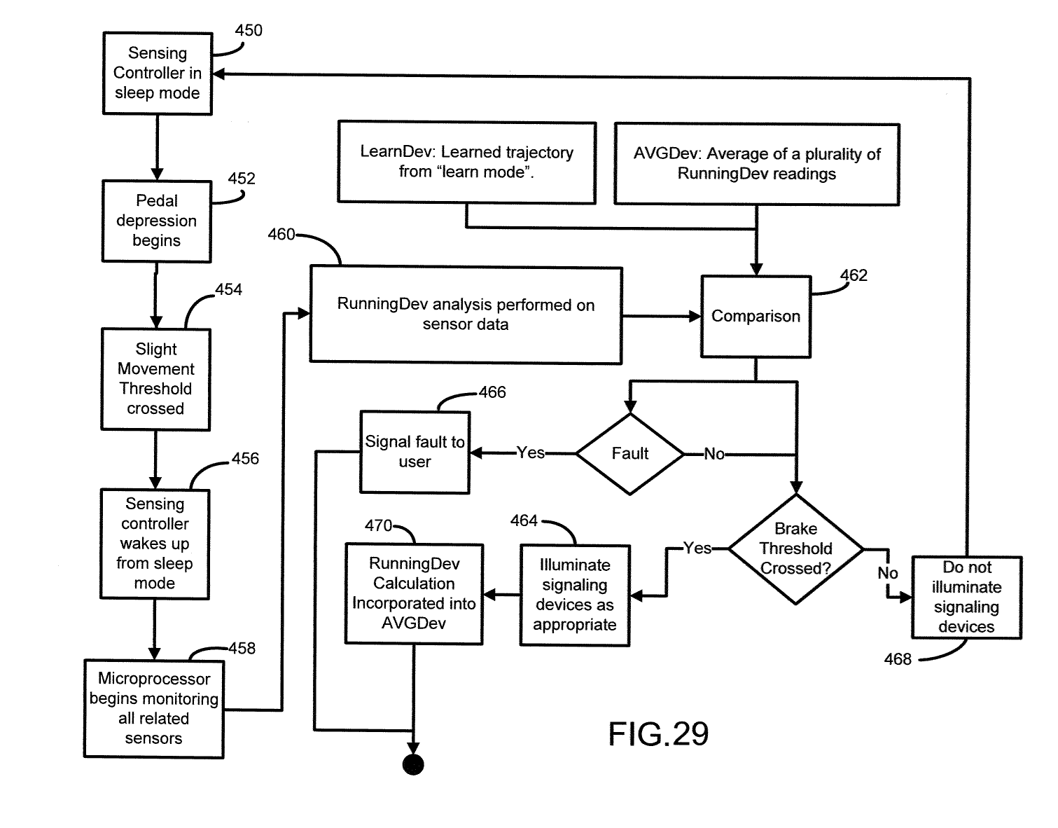

FIG. 29 depicts another flowchart detailing a number of example steps which may be used to detect a condition indicating a signaling device should be illuminated and to command one or more signaling device to illuminate as appropriate. In the example flowchart, the steps shown relate specifically to detecting and reacting to actuation of a brake pedal. Similar steps may be used by a sensing controller to detect and react to other conditions. It should be noted that the flowchart depicted in FIG. 29 begins after a sensing controller has “learned” how to detect the condition of interest. This may, for example, be accomplished by following steps similar to those described in relation to FIG. 26 or FIG. 27. The example flowchart in FIG. 29 may be used in a signaling device system which includes a sensing controller and an additional sensor which is stationary with respect to the vehicle. Specifically, the sensing controller in the example embodiment detailed in the flowchart includes an accelerometer. The additional sensor in the specific embodiment is another accelerometer.

As shown, in step 450 the sensing controller may be in a sleep mode. The sleep mode may be a reduced functionality mode which is used when possible to lower power consumption of a sensing controller. In such a mode, the sensing controller may be monitoring and powering less than all of the sensors included in the sensing controller. For example, only one sensor may be monitored, and data from this sensor may be analyzed to determine when to wake up the sensing controller. Additionally, other non-essential components may be turned off or operate at a reduced level in such a sleep mode. For example, the radio transceiver of the sensing controller may be turned off while the sensing controller is asleep. A sensing controller may enter sleep mode after start-up or a self test upon power on. Additionally, a sensing controller may enter a sleep mode after a predefined period of inactivity is detected.

In step 452, the operator of the vehicle may depress the pedal of the automobile. In step 454, the pedal may become displaced so far as to cross a slight movement threshold or break out of a deadband. The slight movement threshold or deadband may be defined such that the sensing controller is woken up from sleep mode when there is a high likelihood that the vehicle operator is applying the brake. The slight movement threshold or deadband may be set to account for uttering or movement which may occur, but is not a result of an operator displacing the brake pedal. For example, the slight movement threshold or deadband may be defined such that it accounts for any slop in the pedal. The slight movement threshold or deadband may be set such that the sensing controller may be woken up before the pedal is depressed far enough that the brakes are applied and the vehicle consequentially begins to decelerate.

In the event that the slight movement threshold is crossed in step 454, the microprocessor of the sensing controller may wake the sensing controller from sleep mode in step 456. Once out of sleep mode, the microprocessor may begin monitoring the data from all sensors in the sensing controller and may being to receive and monitor data from one or more other sensor which is stationary with respect to the vehicle in step 458. In the example embodiment, the sensing controller includes an accelerometer. Additionally, there is another accelerometer stationary with respect to the vehicle. Additional sensors, for example, a gyroscopic sensor may be included.

In step 460, the microprocessor of the sensing controller may perform a running deviation (RunningDev) analysis on the data from the sensors. This analysis may determine the displacement or travel trajectory of the brake pedal and the amount and direction of displacement of the brake pedal. In the specific example embodiment, this may be accomplished by comparing the outputs of both accelerometers. If the brake pedal is not moving with respect to the vehicle, the outputs of each accelerometer should be substantially similar. When the brake pedal is moving with respect to the vehicle, the accelerometer which is stationary with respect to the vehicle may be used as a baseline to which the pedal mounted accelerometer output may be compared.

In step 462, the microprocessor may conduct a comparison to determine if the displacement trajectory of the brake pedal is indicative of the user displacing the brake pedal to apply the vehicle's brakes. This comparison may involve checking to see if the sensed displacement trajectory and the amount of displacement of the brake pedal substantially matches that of the learn data trajectory from the learn deviation (LearnDev) analysis. In some embodiments, this comparison may also involve matching the sensed displacement data to historical data. This historical data may, be an average (AVGDev) of a plurality of running deviation analyses. This may be done to account for any changes that may be expected over time in the brake pedal trajectory due to brake wear over time for example.

In the event that the sensed displacement data is indicative that the brake has been displaced past a braking threshold, the sensing controller may command that signaling devices in a signaling device system illuminate as appropriate in step 464. The braking threshold may be set at a point further along the displacement trajectory than the slight displacement threshold or deadband. For example, the braking threshold may be set at a point in the travel or displacement trajectory of the brake pedal approximately where the brakes begin to be applied.

In some embodiments, additional logic may be employed to determine if the vehicle is decelerating at a rate which would be indicative of a hard stop or panic stop. In such an event, the sensing controller may command that one or more signaling device in a signaling device system signal a hard stop is occurring. When the running deviation analysis indicates that the brake pedal has been released, the sensing controller may command that any illuminated brake indicators stop signaling that the vehicle is braking.

If the threshold is not crossed the flowchart may proceed to step 468 in which the signals are not commanded to illuminate. In some embodiments, there may be a predetermined period of time which must elapse before the sensing controller proceeds to step 468. In some embodiments, if it is determined that the brake pedal has returned to an at rest position, the sensing controller may proceed to step 468. From step 468, the sensing controller may return to step 450 in which the sensing controller operates in sleep state. In some embodiments, the sensing controller may determine that the brake pedal is substantially stationary for a predetermined period of time before transitioning into the sleep state.

The sensing controller may also monitor for fault conditions as the running deviation analysis on incoming sensor data is conducted. This fault monitoring may occur throughout the whole brake pedal actuation; before and after the braking threshold is crossed. This fault detection may involve monitoring the displacement trajectory to determine if it deviates outside of a predetermined relationship from the learned deviation analysis trajectory and/or the historical data analysis trajectory. For example, this may detect if the sensing controller has become detached from the pedal, or may have otherwise moved from its original position. In this event, a fault may be signaled to alert the user. The user may then be required and/or notified to put the sensing controller through the learn mode calibration process again. Additionally, fault monitoring may involve ensuring that all expected sensor inputs are received and within an expected range. In the event of an expected sensor input not being received or a communication failure, a fault may be signaled. The fault condition may be communicated to the user in step 466.

In various embodiments, the running deviation analysis may be incorporated into a historical data analysis. In the example embodiment, this occurs in step 470 after it is determined that a braking threshold has been crossed. In other embodiments, this may be done every time that the sensing controller transitions from a sleep state to an awakened state. This data may be used to refine the various thresholds for the sensing controller in some embodiments. That is, using the historical data, the sensing controller may adjust threshold set points such that they are better optimized over time. For example, the historical data may be used determine if the set point for the slight movement or displacement threshold or deadband is often causing the controller to wake up when the subsequent running deviation analysis does not indicate that the user has actuated the brake pedal to apply the vehicle brakes. Upon such a determination, the slight movement threshold or deadband may be adjusted such that it is crossed at a point farther along in the displacement trajectory.

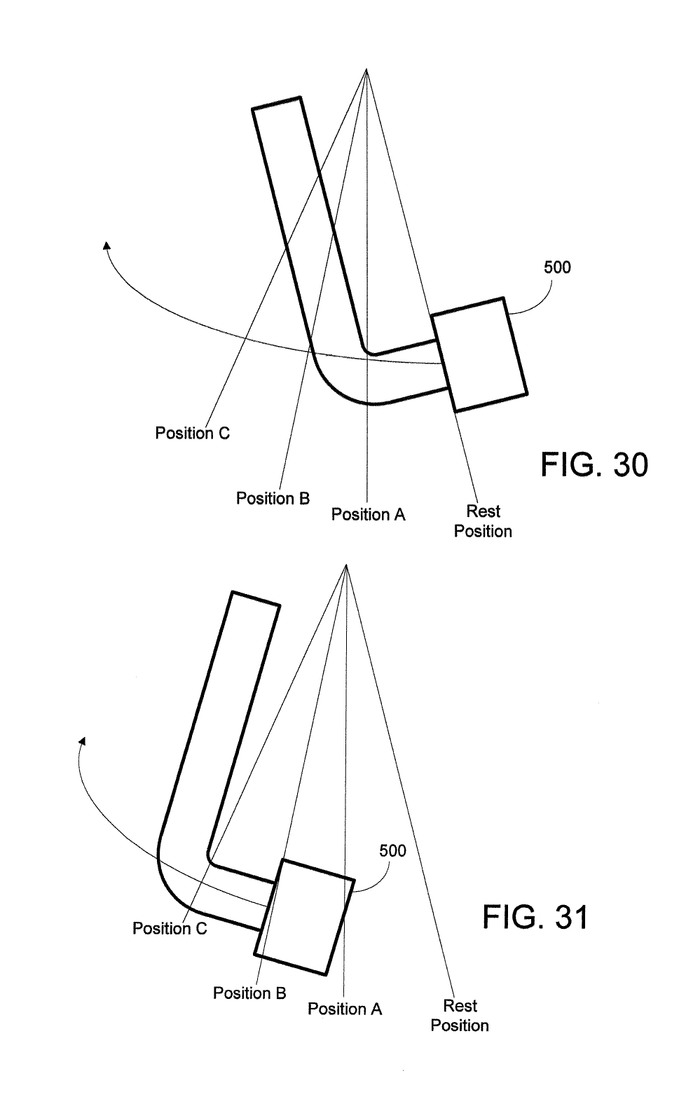

The progression of FIG. 30 to FIG. 31 depicts a representational example of a brake pedal 500 being depressed. As shown, in FIG. 30, the brake pedal 500 is depicted in an at rest position. In this position, a sensing controller on the brake pedal 500 (not shown) may be in a sleep mode. In such a mode, the sensing controller may monitor less than the total number of sensors in the system. For example, the sensing controller may only monitor a single sensor in the system. In the event that this sensor indicates the user is depressing the brake pedal 500 (e.g. a slight movement threshold has been crossed) the sensing controller may then wake up and begin to monitor data from all sensors in the system.

In the example embodiment shown in FIGS. 30-31 a number of in transit positions are also depicted. Specifically, the example embodiment depicts a “Position A”, “Position B”, and a “Position C”. As the user depresses the brake pedal 500, the brake pedal 500 will travel through these positions. “Position A” may, for example, be a slight movement threshold. One of “Position B” and “Position C” may, for example, be a brake applied threshold. A table of simplified, illustrative sensor outputs at these positions for a specific example sensing controller system is shown in Table 1 as follows:

| | | | Acceler- | Acceler- | |
|---|---|---|---|---|---|
| | | | ometer | ometer | |
| | | Gyroscopic | 1 Pedal | 2 Vehicle | Magnetic |
| Sample | | Sensor | Sensor | Sensor | Sensor |
| Time | | X, Y, Z | X, Y, Z | X, Y, Z | X, Y, Z |
| (ms) | Position | (m/s²) | (m/s²) | (m/s²) | (m/s²) |
| 0 | Rest | 1, 1, 1 | 1, 2, 4 | 1, 2, 4 | 1, 1, 1 |
| | Position | | | | |
| 250 | Position A | 1, 1, 1 | 1, 2, 12 | 1, 2, 4 | 3, 3, 3 |
| 500 | Position B | 6, 3, 3 | 1, 2, 12 | 1, 2, 4 | 6, 3, 3 |
| 750 | Position C | 9, 4, 3 | 1, 2, 12 | 1, 2, 4 | 9, 4, 3 |
| 1000 | Position B | 6, 3, 3 | 1, 2, −1 | 1, 2, 4 | 6, 3, 3 |
| 1250 | Position A | 1, 1, 1 | 1, 2, −1 | 1, 2, 4 | 3, 3, 3 |

As shown, the sensor controller system includes 4 sensors: a Gyroscopic sensor, two accelerometers (accelerometer1 and accelerometer2), and a Magnetic sensor. Additionally, one of the accelerometers, accelerometer1, is coupled to the brake pedal 500 while the other, accelerometer2, is stationary with respect to the vehicle. The gyroscopic sensor and magnetic sensor are attached to the brake pedal 500 in the example embodiment. Other embodiments may use a different number of sensors or different sensors. Including a larger number of sensors in the system may increase the accuracy of brake pedal 500 actuation detection. Though sensor outputs from all sensors are shown for all positions, in some embodiments, the sensing controller may be in a sleep mode until a slight movement threshold is reached. In such embodiments, there may only be one sensor output until the threshold is reached. Additionally, the interval at which sensor outputs are read may differ in various embodiments.

The illustrative outputs in Table 1 depict data which may be produced by a vehicle in motion. The example data is taken over a period of time in which the brake pedal 500 is depressed and released by the vehicle operator. As the pedal is depressed, the sensor outputs change from those produced when the brake pedal 500 is at rest. By analyzing data produced by the sensors, the sensing controller (or another controller included in the system) may detect this change and register that the brake pedal is being depressed. This may be accomplished by determining a deviation between sensor outputs learned in a learn mode and live incoming data from the sensors. Additionally or alternatively, this may be accomplished by determining a deviation between sensor outputs produced in past brake pedal 500 actuations and those produced in live incoming data from the sensors. The data from accelerometer1 and accelerometer2 may be compared to determine the brake pedal 500 travel speed relative to the vehicle. By analyzing the data to determine if the brake pedal 500 is traveling along the learned or historical trajectory the sensing controller may detect that the user is actuating the brake pedal 500 and commanding appropriate signaling devices to illuminate. By monitoring the speed at which the brake pedal 500 is being depressed along the trajectory, the sensing controller may determine a hard stop is occurring and commanding appropriate signaling devices to illuminate accordingly. As mentioned above, the data may be monitored for indications that a fault condition exists (e.g. a sensor is malfunctioning, one or more sensors has moved from its expected position, etc.).

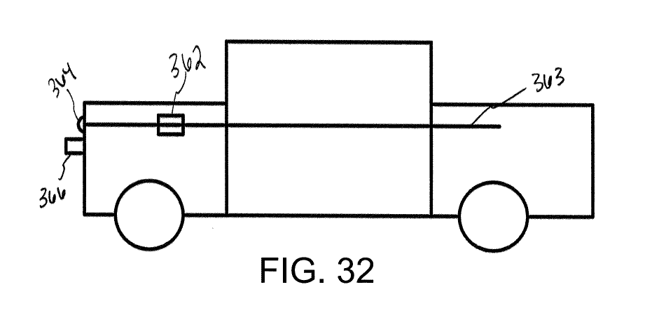

FIG. 32 depicts a representational example embodiment of another sensing controller 362 which may be used to detect a condition indicating a signaling device should be illuminated. In the example embodiment, the sensing controller 362 may be configured to detect that a pre-existing or stock signal 364 on a vehicle is illuminating. The sensing controller 362 may then issue a command to a non-stock signaling device(s) 366 (e.g. any such devices described herein) on the vehicle to illuminate in a cooperative manner for instance. This may be particularly desirable on vehicles which have sub-optimally placed or dim stock lighting. For a specific example, a sensing controller 362 may detect that a pre-existing brake light on a vehicle is illuminating and send out a signal to the appropriate non-stock signaling devices associated with the sensing controller 362 to illuminate as brake lights.

In one specific embodiment, a sensing controller 362 may include a current sensor or inductance based sensor. The current sensor may be used to sense current flow through wiring 363 to stock lighting 364 on the vehicle. In the event that the sensed current flow exceeds a predetermined threshold, the sensing controller 362 may determine that the stock lighting 364 is being illuminated. Upon such a determination, the sensing controller 362 may send a command to non-stock signaling device(s) 366 in a signaling device system to illuminate. In embodiments where the sensing controller 362 includes a current sensor, the sensing controller 362 may be configured to be removably clipped around the wiring 363 of the desired lighting such that the current sensor may sense the current through the wiring 363. In some embodiments, for example, a sensing controller 362 may include a clamshell like mechanism, or include a hinge which may be biased or snapped/locked closed to facilitate placement around the wiring 363. The sensing controller 362 may be clipped to the wiring 363 in any suitable location (e.g. a location where the wiring 363 is easily accessible). In other embodiments, the sensing controller 362 may not include a current sensor. In such embodiments, the sensing controller 362 may include another sensor which would be suitable to detect illumination of stock lighting 364 on the vehicle. In some embodiments, for example, a light or photo sensor may be used to detect whether a stock light 364 is illuminated.

A sensing controller 362 may include a number of other components. For example, a sensing controller 362 may have components similar to the sensing controller 300 depicted in FIG. 23. The sensing controller 362 may include a radio unit (e.g. transceiver or transmitter) to communicate with and command other components of a signaling device system. The sensing controller 362 may also include a processor to process sensor data and determine whether the stock lighting 364 on the vehicle is illuminating. The sensing controller 362 may also include an onboard power source such as a battery which powers the sensing controller 362.

While the above description contains many specifics, these should not be constructed as limitations on the scope of the disclosure, but as exemplifications of the presently preferred embodiments thereof. Many other variations are possible and considered within the teachings and scope of this disclosure. A contemplated system may use all or parts of those systems described herein. Additionally it is contemplated that a system may incorporate future safety devices to compliment and improve the function and safety benefits for an antique vehicle owner.

Various alternatives and modifications can be devised by those skilled in the art without departing from the disclosure. Accordingly, the present disclosure is intended to embrace all such alternatives, modifications and variances. Additionally, while several embodiments of the present disclosure have been shown in the drawings and/or discussed herein, it is not intended that the disclosure be limited thereto, as it is intended that the disclosure be as broad in scope as the art will allow and that the specification be read likewise. Therefore, the above description should not be construed as limiting, but merely as exemplifications of particular embodiments. And, those skilled in the art will envision other modifications within the scope and spirit of the claims appended hereto. Other elements, steps, methods and techniques that are insubstantially different from those described above and/or in the appended claims are also intended to be within the scope of the disclosure.

The embodiments shown in drawings are presented only to demonstrate certain examples of the disclosure. And, the drawings described are only illustrative and are non-limiting. In the drawings, for illustrative purposes, the size of some of the elements may be exaggerated and not drawn to a particular scale. Additionally, elements shown within the drawings that have the same numbers may be identical elements or may be similar elements, depending on the context.

Where the term “comprising” is used in the present description and claims, it does not exclude other elements or steps. Where an indefinite or definite article is used when referring to a singular noun, e.g. “a” “an” or “the”, this includes a plural of that noun unless something otherwise is specifically stated. Hence, the term “comprising” should not be interpreted as being restricted to the items listed thereafter; it does not exclude other elements or steps, and so the scope of the expression “a device comprising items A and B” should not be limited to devices consisting only of components A and B. This expression signifies that, with respect to the present disclosure, the only relevant components of the device are A and B.

Furthermore, the terms “first”, “second”, “third” and the like, whether used in the description or in the claims, are provided for distinguishing between similar elements and not necessarily for describing a sequential or chronological order. It is to be understood that the terms so used are interchangeable under appropriate circumstances (unless clearly disclosed otherwise) and that the embodiments of the disclosure described herein are capable of operation in other sequences and/or arrangements than are described or illustrated herein.

What is claimed is:

1. A remote controlled vehicular light bulb said remote controlled light bulb comprising:
A lighting element;
A radio unit;
A controller, the controller configured to control illumination of the lighting element based upon a control signal received by the radio unit; and
A housing, the housing configured to interface and receive power from a standard vehicular light bulb socket, the housing comprising a base and a bulb.

2. The remote controlled vehicular light bulb of claim 1, wherein the lighting element includes at least one light emitting diode.

3. The remote controlled vehicular light bulb of claim 1, wherein the lighting element includes a plurality of light sources which are configured to be illuminated in tandem and/or individually as commanded by the controller.

4. The remote controlled vehicular light bulb of claim 1, wherein the controller is configured to transmit a repeater signal via the radio unit.

5. The remote controlled vehicular light bulb of claim 1, wherein the controller is configured to detect a fault condition in the remote controlled vehicular light bulb.

6. The remote controlled vehicular light bulb of claim 5, wherein the controller is configured to transmit a fault indication signal via the radio unit.

7. The remote controlled vehicular light bulb of claim 1, wherein the controller and radio unit are embedded in a single integrated circuit.

8. A remotely controlled vehicular lighting system, the system comprising:
At least one vehicular light, each of the at least one vehicular light comprising, radio unit, and a microprocessor;
A controller, the controller configured to generate a control signal, the control signal comprising: a first unique identifier which is associated with the controller, a second unique identifier which is associated with the intended recipient vehicular light of the at least one vehicular light, and a command;
Wherein, the microprocessor of each of the at least one vehicular light is configured to receive, via the radio unit, the control signal from the controller and execute the command if the vehicular light has been operatively paired with the controller associated with the first unique identifier and the vehicular light is associated with the second unique identifier.

9. The remotely controlled vehicular lighting system of claim 8, wherein each of the at least one vehicular light is configured to interface and draw power from a pre-existing vehicular light bulb socket.

10. The remotely controlled vehicular lighting system of claim 8, wherein the command specifies a desired behavior of the vehicular light.

11. The remotely controlled vehicular lighting system of claim 8, wherein each of the at least one vehicular light includes a lighting element.

12. The remotely controlled vehicular lighting system of claim 11, wherein the command specifies whether the lighting element should illuminate and/or in what fashion the lighting element should illuminate.

13. The remotely controlled vehicular lighting system of claim 8, wherein the microprocessor of each of the at least one vehicular light is further configured to generate a status signal, via the radio unit, indicating the status of that vehicular light.

14. The remotely controlled vehicular lighting system of claim 13, wherein the controller includes an indicia, the indicia indicating the status of one of the at least one vehicular light as indicated by the status signal generated by that vehicular light.

15. The remotely controlled vehicular lighting system of claim 8, wherein the controller includes an actuator, the actuator configured for use in selecting between the command to be sent in the control signal from a plurality of selectable commands.

16. The remotely controlled vehicular lighting system of claim 8, wherein the control signal generated by the controller is encrypted and the microprocessor of each of the at least one vehicular light is configured to decrypt the signal.

17. The remotely controlled vehicular lighting system of claim 8, wherein the controller includes an on-board power source and is configured to be removably coupled to a surface.

18. A remote controlled vehicular light said remote controlled light comprising:
A lighting element;
A radio unit;
A controller, the controller configured to control illumination of the lighting element based upon a control signal received by the radio unit, the controller only acting on the control signal when the control signal includes an expected unique identifier; and
A housing, the housing comprising a base and a bulb, the housing configured to interface and receive power from a standard vehicular light bulb socket or be configured to be removably mountable to a vehicle.

19. The remote control vehicular light of claim 18, wherein the control signal includes a command, the command specifying whether the lighting element should illuminate and/or in what fashion the lighting element should illuminate.

20. The remote control vehicular light of claim 18, wherein the controller is configured to detect one or more fault condition in the remote control vehicular light and, when one of the one or more fault condition is detected, transmit a status signal indicating presence of that fault condition.
